(19) United States
(12) Patent Application Publication
(10) Pub. No.: US 2026/0159364 A1
(43) Pub. Date: Jun. 11, 2026

(54) PORTABLE OMNIDIRECTIONAL JACKING AND MOVING SYSTEM FOR RAPID RELOCATION OF INOPERABLE VEHICLES

(71) Applicant: Owen Zhuang Sun, Torrance, CA (US)

(72) Inventor: Owen Zhuang Sun, Torrance, CA (US)

(21) Appl. No.: 19/416,460

(22) Filed: Dec. 11, 2025

Related U.S. Application Data
(60) Provisional application No. 63/730,952, filed on Dec. 11, 2024.

(51) Int. Cl. B66F 5/04

(52) U.S. Cl. CPC B66F 5/04; B66F 2700/052

(57) ABSTRACT

A portable relocation system for relocating an inoperable vehicle may include a plurality of relocation modules configured to be positioned at designated jacking points of the inoperable vehicle. Each relocation module may include a chassis, a hydraulic jack mounted to the chassis, a plurality of mecanum wheels mounted to the chassis, and a local computer configured to control the hydraulic jack and mecanum wheels. The hydraulic jack may lift the inoperable vehicle a predetermined distance relative to a ground surface. The mecanum wheels may enable omnidirectional movement. The system may include a central control unit communicatively coupled to each local computer. A wireless human-machine interface may communicate with the central control unit. The central control unit may synchronize lift and omnidirectional movement by exchanging real-time data and control commands with each local computer.

### CROSS-REFERENCE TO RELATED APPLICATIONS

The present application claims the benefit under 35 U.S.C. § 119(e) of U.S. Provisional Application No. 63/730,952, filed Dec. 11, 2024, which is herein incorporated by reference in the entirety.

### TECHNICAL FIELD

The present disclosure relates to vehicle handling and transportation systems, and more particularly to, a portable omnidirectional jacking and moving system for rapid relocation of inoperable vehicles.

### BACKGROUND

Inoperable vehicles, whether due to mechanical failure during driving or immobilization from accidents on interstate highways, often obstruct traffic, causing significant delays and frustration for other drivers. Vehicle owners must wait for tow trucks to clear the obstruction, which can exacerbate traffic bottlenecks, leading to wasted time and heightened driver anxiety. More critically, police vehicles and tow trucks dispatched to assist may themselves become trapped in the resulting congestion.

Conventional techniques to move inoperable vehicles include using wheel dollies, which allows police officers to move a disabled vehicle to the shoulder without waiting for a tow truck. However, such approach typically requires several people to manually push the vehicle, especially if it is large. Further, commercially available electric powered pushing devices reduce physical effort but still require two people, one to operate the vehicle by placing the transmission in neutral. Moreover, many electric vehicles lack a neutral setting, making such devices less feasible.

As such, there is a need for a system and method which cures one or more shortfalls of the above identified approaches.

### SUMMARY

A portable relocation system for relocating an inoperable vehicle is disclosed, in accordance with one or more embodiments of the present disclosure. In embodiments, the portable relocation system includes a plurality of relocation modules configured to be positioned at a plurality of designated jacking points of the inoperable vehicle. In embodiments, each relocation module includes a chassis configured to support each relocation module. In embodiments, each relocation module includes a hydraulic jack mounted to the chassis, where the hydraulic jack is configured to lift the inoperable vehicle a predetermined distance relative to a ground surface. In embodiments, each relocation module includes a plurality of mecanum wheels mounted to the chassis, where the plurality of mecanum wheels are configured to enable omnidirectional movement. In embodiments, each relocation module includes a local computer configured to control the hydraulic jack and the plurality of mecanum wheels. In embodiments, the portable relocation system includes a central control unit communicatively coupled to each local computer of each relocation module. In embodiments, the portable relocation system includes a wireless human-machine interface in communication with the central control unit, where the central control unit synchronizes lift and omnidirectional movement of the inoperable vehicle by exchanging real-time data and control commands with each local computer of each relocation module.

A method for relocating an inoperable vehicle using a portable relocation system is disclosed, in accordance with one or more embodiments of the present disclosure. In embodiments, the method includes positioning a plurality of relocation modules at respective designated jacking points of the inoperable vehicle, each relocation module including a hydraulic jack, a plurality of mecanum wheels, and a local computer. In embodiments, the method includes actuating the hydraulic jack for each relocation module simultaneously across the plurality of relocation modules to lift the inoperable vehicle a predetermined distance relative to a ground surface. In embodiments, the method includes directing omnidirectional movement of the inoperable vehicle using the plurality of mecanum wheels to move the inoperable vehicle to a predetermined location. In embodiments, the method includes retracting the hydraulic jack for each relocation module simultaneously across the plurality of relocation modules to lower the inoperable vehicle to the ground surface.

A relocation module for relocating an inoperable vehicle is disclosed, in accordance with one or more embodiments of the present disclosure. In embodiments, the relocation module includes a chassis configured to fit beneath a plurality of vehicle pinch-weld jacking points. In embodiments, the relocation module includes a hydraulic jack including a four-stage telescopic cylinder mounted to the chassis. In embodiments, the relocation module includes a plurality of mecanum wheels mounted to the chassis, where the plurality of mecanum wheels are configured to enable omnidirectional movement. In embodiments, the relocation module includes a gear pump operatively coupled to an electric motor. In embodiments, the relocation module includes a solenoid-actuated directional control valve fluidly coupled between the hydraulic jack and the gear pump. In embodiments, the relocation module includes a load cell mounted on the hydraulic jack, where the load cell is configured to measure distributed vehicle weight of the inoperable vehicle. In embodiments, the relocation module includes a local computer configured to control hydraulic jack extension and retraction of the four-stage telescopic cylinder and mecanum wheel motion of the plurality of mecanum wheels based on real-time sensor feedback from the load cell.

It is understood that the foregoing general description and the following detailed description are illustrative and explanatory only, and are not intended to limit the scope of the invention as claimed. The accompanying drawings, which are incorporated into and form part of this specification, illustrate embodiments of the invention and, together with the general description, serve to explain its principles.

### BRIEF DESCRIPTION OF THE DRAWINGS

The individual components of the system can be better understood by referring to the accompanying figures in which:

FIG. 1A is an isometric view of a jacking and moving system for transporting an inoperable vehicle, in accordance with one or more embodiments of the present disclosure.

FIG. 1B is an elevational view of the jacking and moving system positioned beneath a vehicle prior to jacking, in accordance with one or more embodiments of the present disclosure.

FIG. 1C is an elevational view of the jacking and moving system with the vehicle in a lifted state, in accordance with one or more embodiments of the present disclosure.

FIG. 2A is an elevational view of a relocation module of the system prior to hydraulic extension, in accordance with one or more embodiments of the present disclosure.

FIG. 2B is an elevational view of a relocation module of the system following hydraulic extension, in accordance with one or more embodiments of the present disclosure.

FIG. 2C is an isometric, transparent view of a relocation module of the system with the hydraulic jack extended, in accordance with one or more embodiments of the present disclosure.

FIG. 2D is an isometric bottom view of a relocation module of the system with the hydraulic jack extended, viewed from the hydraulic jack side, in accordance with one or more embodiments of the present disclosure.

FIG. 2E is an isometric top view of a relocation module of the system with the hydraulic jack extended, viewed from the hydraulic jack side, in accordance with one or more embodiments of the present disclosure.

FIG. 2F is an isometric bottom view of a relocation module of the system with the hydraulic jack extended, viewed from the swivel caster side, in accordance with one or more embodiments of the present disclosure.

FIG. 2G is an isometric view of a relocation module of the system with the hydraulic jack extended, viewed from the swivel caster side, in accordance with one or more embodiments of the present disclosure.

FIG. 2H is a top plan view of a relocation module of the system, in accordance with one or more embodiments of the present disclosure.

FIG. 2I is a bottom plan view of a relocation module of the system, in accordance with one or more embodiments of the present disclosure.

FIG. 2J is an isometric view of a partial relocation module highlighting the hydraulic jack and its supporting chassis, in accordance with one or more embodiments of the present disclosure.

FIG. 2K is an exploded view of the partial relocation module shown in FIG. 2J, in accordance with one or more embodiments of the present disclosure.

FIG. 2L is an isometric top view of a partial jacking and moving module with the top plate and mecanum wheels removed, in accordance with one or more embodiments of the present disclosure.

FIG. 2M is an isometric bottom view of the partial jacking and moving module shown in FIG. 2L, in accordance with one or more embodiments of the present disclosure.

FIG. 2N is an exploded view of the partial jacking and moving module shown in FIG. 2L, in accordance with one or more embodiments of the present disclosure.

FIG. 3A is an isometric view of the chassis that supports the hydraulic jack, in accordance with one or more embodiments of the present disclosure.

FIG. 3B is an exploded view of the chassis that supports the hydraulic jack, in accordance with one or more embodiments of the present disclosure.

FIG. 4A is an isometric top view of the platform forming part of the jack-supporting chassis, in accordance with one or more embodiments of the present disclosure.

FIG. 4B is an isometric bottom view of the platform forming part of the jack-supporting chassis, in accordance with one or more embodiments of the present disclosure.

FIG. 5A is an isometric view of the low-profile electric hydraulic jack, in accordance with one or more embodiments of the present disclosure.

FIG. 5B is an exploded view of the low-profile electric hydraulic jack, in accordance with one or more embodiments of the present disclosure.

FIG. 6A is an isometric view of the hydraulic control box mounted on a swivel caster, along with additional hydraulic control components, in accordance with one or more embodiments of the present disclosure.

FIG. 6B is an exploded view of the hydraulic control box mounted on a swivel caster, along with additional hydraulic control components, in accordance with one or more embodiments of the present disclosure.

FIG. 6C is an isometric, transparent view of the hydraulic control box and the bracket for swivel caster attachment, in accordance with one or more embodiments of the present disclosure.

FIG. 6D is an isometric, transparent view of the hydraulic control components, including the gear pump, electrical motor, solenoid-actuated directional control valve, power supply, oil reservoir, and hoses, in accordance with one or more embodiments of the present disclosure.

FIG. 6E is isometric view of the hydraulic control components, in accordance with one or more embodiments of the present disclosure.

FIG. 7A is an isometric view of the gear pump, electric motor, and motor support, in accordance with one or more embodiments of the present disclosure.

FIG. 7B is an isometric, transparent view of the gear pump, electric motor, and motor support, in accordance with one or more embodiments of the present disclosure.

FIG. 7C is an exploded view of the gear pump, electric motor, and motor support, in accordance with one or more embodiments of the present disclosure.

FIG. 8 is an isometric view of the oil reservoir, in accordance with one or more embodiments of the present disclosure.

FIG. 9A is an isometric view of the central control unit, including the central computer, remote controller, and control unit case, in accordance with one or more embodiments of the present disclosure.

FIG. 9B is an exploded view of the central control unit, including the central computer, remote controller, and control unit case, in accordance with one or more embodiments of the present disclosure.

FIG. 9C is a plan view of the central control unit, including the central computer, remote controller, and control unit case, in accordance with one or more embodiments of the present disclosure.

FIG. 10 is an isometric view of the wireless human machine interface, in accordance with one or more embodiments of the present disclosure.

FIG. 11 is a circuit diagram of the jacking and moving system, in accordance with one or more embodiments of the present disclosure.

FIG. 12 shows an isometric view of the hydraulic system, in accordance with one or more embodiments of the present disclosure.

FIG. 13A illustrates a fluid power diagram of a hydraulic system during extension of the single-acting hydraulic jack, in accordance with one or more embodiments of the present disclosure.

FIG. 13B illustrates a fluid power diagram of a hydraulic system during retraction of the single-acting hydraulic jack, wherein hydraulic oil returns to the oil reservoir, in accordance with one or more embodiments of the present disclosure.

FIG. 14 illustrates a flowchart depicting of method of operating the system, in accordance with one or more embodiments of the present disclosure.

### DETAILED DESCRIPTION

Reference will now be made in detail to the subject matter disclosed, as illustrated in the accompanying drawings.

Inoperable vehicles on highways and roadways present significant challenges for traffic management and public safety. When vehicles become disabled due to mechanical failure, accidents, or other circumstances, they often obstruct traffic lanes, creating dangerous conditions and causing substantial delays. Conventional approaches to clearing these obstructions rely on tow trucks, which must navigate through the resulting traffic congestion to reach the disabled vehicle. This process can take considerable time, during which traffic continues to back up, emergency responders may be delayed, and the risk of secondary accidents increases.

Existing solutions for moving disabled vehicles have several limitations. Conventional wheel dollies require multiple personnel to manually push the vehicle and necessitate placing the vehicle's transmission in neutral, which is not possible with many electric vehicles or vehicles with certain types of mechanical failures. Electric-powered pushing devices reduce physical effort but still require at least two operators and face the same neutral transmission requirement. These methods are also limited in their directional capability, typically only allowing forward or backward movement, unless a separate operator controls the steering wheel, which restricts maneuverability in congested environments.

Embodiments of the present disclosure are directed to a portable omnidirectional relocation system. For example, the system may include a plurality of relocation modules and a central control unit. Each module may include, but is not limited to, a chassis configured to support a single-acting hydraulic jack with a multi-stage telescopic cylinder, mecanum wheels for omnidirectional movement, a gear pump powered by an electric motor, a solenoid-actuated directional control valve, a load cell for lift verification, and a local computer for autonomous operation. The modules may be specifically designed to fit beneath standard passenger vehicles at designated pinch weld jacking points, with a low-profile configuration that accommodates vehicles with limited ground clearance.

The system may be configured to operate through coordinated control of all four modules via a wireless human-machine interface that communicates with a central computer. For example, the telescopic jacks may be configured to extend up to eight inches to provide sufficient lift height for various vehicle types, while load cells may be configured to provide real-time feedback to detect tire lift-off. Once elevated, the mecanum wheels may enable omnidirectional movement without requiring the vehicle to be placed in neutral, allowing precise navigation through congested areas. The wireless interface may be configured to provide intuitive operation through joystick inputs and command buttons, enabling single-operator control of both lifting and movement functions.

It is contemplated herein that the system of the present disclosure may provide a number of advantages of the previous approaches. For example, the compact, portable design of the present disclosure may enable transportation by motorcycle, allowing rapid deployment through congested traffic where conventional tow trucks would be delayed. By way of another example, the system of the present disclosure includes mecanum wheels that provide omnidirectional movement capability to allow for precise maneuvering in any direction without changing vehicle orientation, which may be particularly advantageous in confined spaces or complex traffic situations. Further, the system of the present disclosure may be operated by a single operator to eliminate the need for multiple personnel. By way of another example, the system of the present disclosure may operate without placing the vehicle in neutral, such that the system may be compatible with electric vehicles and vehicles with transmission problems. Further, the system of the present disclosure may allow for automated load sensing and coordinated control across all four modules to ensure safe, balanced lifting and movement operations, reducing the risk of vehicle damage or operator injury.

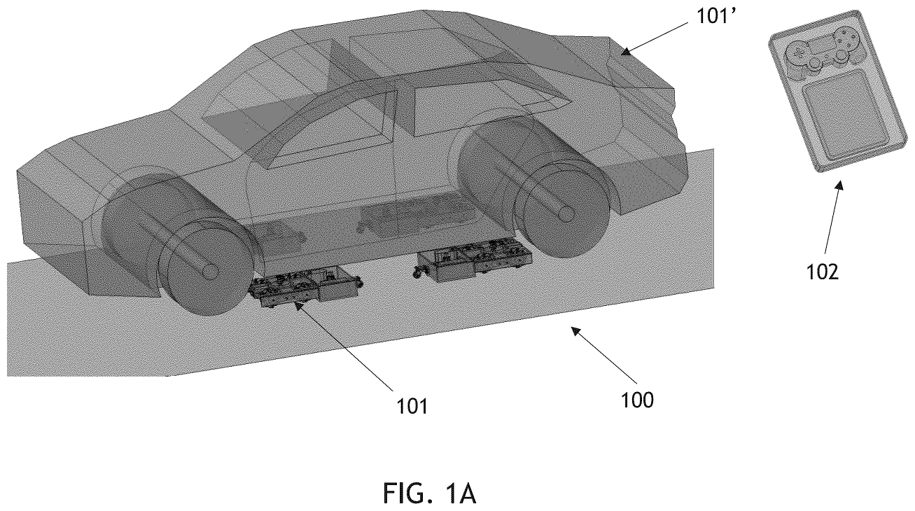

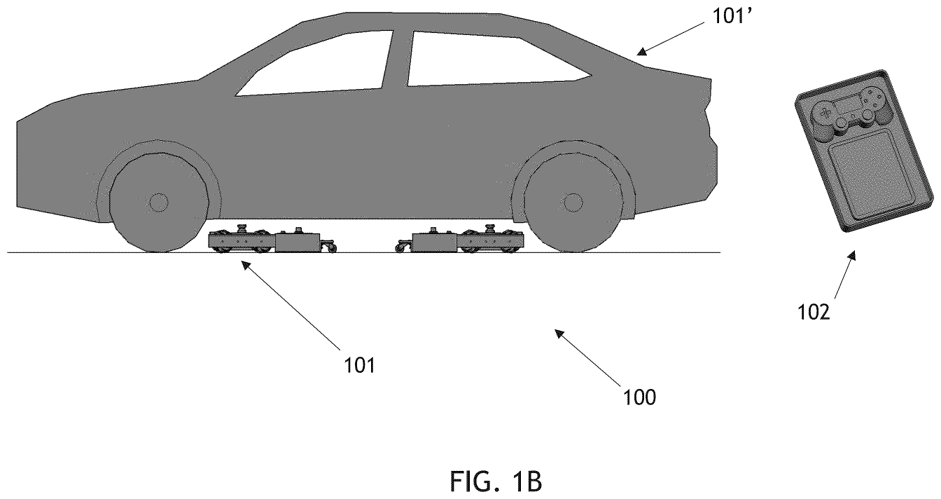

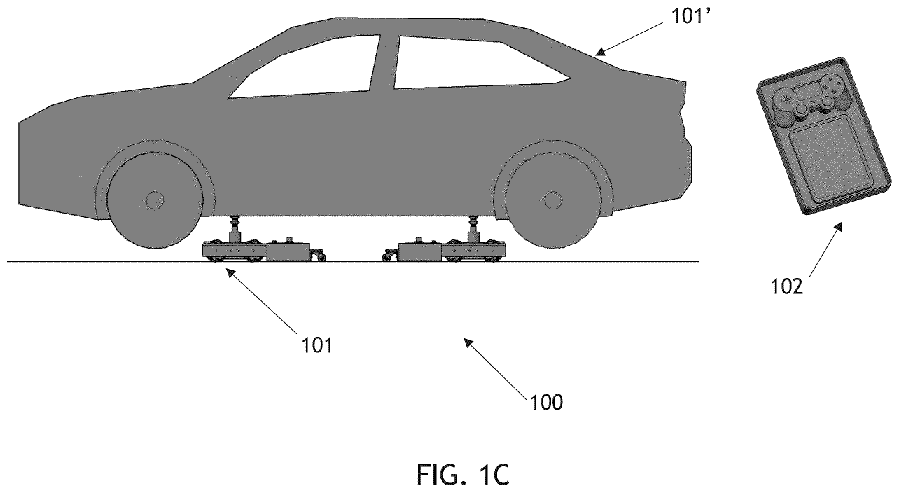

FIGS. 1A-14 generally illustrate a relocation system 100, in accordance with one or more embodiments of the present disclosure.

FIGS. 1A-1C illustrate the system 100, in accordance with one or more embodiments of the present disclosure. In particular, FIG. 1A is an isometric view of a jacking and moving system for transporting an inoperable vehicle, FIG. 1B is an elevational view of the jacking and moving system positioned beneath a vehicle prior to jacking, and FIG. 1C is an elevational view of the jacking and moving system with the vehicle in a lifted state.

In embodiments, the system 100 may be configured for relocating inoperable vehicles from obstructive locations to safe areas. Referring to FIG. 1A, in embodiments, the system 100 may include a plurality of relocation modules 101 and a central control unit 102. For example, the plurality of relocation modules 101 may be positioned at designated jacking points of a vehicle 101′, where each relocation module 101 may be configured to support a portion of the vehicle's weight during lifting and movement operations. For instance, in a non-limiting example, the system 100 may include four relocation modules 101 positioned at four jacking points of the vehicle 101′, e.g., front-left, front-right, rear-left, and rear-right. In this regard, as shown in FIG. 1A, the relocation modules 101 may be distributed to support the vehicle 101′ at pinch weld areas beneath the vehicle body, providing balanced load distribution during lifting operations. It is contemplated herein the transparent rendering of the vehicle 101′ in FIG. 1A allows visualization of the spatial arrangement of the relocation modules 101 relative to the vehicle's undercarriage and is provided merely for illustrative purposes and shall not be construed as limiting the scope of the present disclosure.

The central control unit 102 may be positioned separately from the vehicle 101′ (e.g., remote and external to the vehicle 101′) and may be configured to coordinate operations across the plurality of relocation modules 101 through wireless communication, as will be discussed further herein. For example, the central control unit 102 may be positioned adjacent to the vehicle 101′ and may include a wireless human-machine interface for operator control.

Referring to FIG. 1B, the relocation system 100 may be shown in a pre-lift configuration immediately prior to jacking operations. In embodiments, each relocation module 101 may be positioned at a designated jacking point of the vehicle 101′, where each relocation module 101 may be in a retracted state to fit within the clearance between the vehicle's undercarriage and the ground surface. For example, the low-profile design of each relocation module 101 may enable positioning beneath the vehicle 101′ at pinch weld jacking points without requiring preliminary elevation of the vehicle 101′.

Referring to FIG. 1C, the relocation system 100 may be configured to elevate the vehicle 101′ to a lifted state for omnidirectional movement operations. For example, as will be discussed further herein, each relocation module 101 may extend and cause all four tires to lift off the ground a predetermined amount, providing sufficient ground clearance for subsequent vehicle relocation. For instance, the plurality of modules 101 may maintain the vehicle 101′ in a stable, level orientation during the lifted state, where the vehicle's weight may be distributed across the plurality of relocation modules 101. The central control unit 102 may coordinate the synchronized lifting operations and may enable the operator to control subsequent movement through the wireless human-machine interface, as will be discussed further herein.

In embodiments, the central control unit 102 may be communicatively coupled to each local computer within the plurality of relocation modules 101. For example, the central control unit 102 may synchronize lift and omnidirectional movement of the vehicle 101′ by exchanging real-time data and control commands with each local computer. The wireless human-machine interface may be in communication with the central control unit 102 to enable operator input and system control.

It is contemplated herein that the relocation system 100 may be configured for transportation on a variety of vehicles for rapid deployment through congested traffic. For example, the compact and portable design of the system 100 may enable transportation by motorcycle, ATV, utility vehicle, pickup truck, or other compact transport vehicle, allowing police officers or emergency responders to navigate between blocked lanes without delay, reaching disabled vehicles more quickly than conventional tow trucks. By way of another example, the system 100 may be deployed by third-party contractors authorized to temporarily move vehicles off highways until tow trucks arrive.

Further, it is contemplated herein that the relocation system 100 may be configured for use by automotive mechanics to move inoperable vehicles from parking lots into repair shops. For example, the system 100 may provide a solution for relocating vehicles in limited-space environments where conventional towing methods may be impractical. The omnidirectional movement capability may enable precise maneuvering within confined areas such as service bays or crowded parking facilities.

The relocation system 100 may enable operation without placing the vehicle transmission in neutral. For example, the system 100 may be suitable for electric vehicles that lack a neutral setting, as well as vehicles with transmission problems or mechanical failures that prevent normal gear selection. The mecanum wheels integrated into each relocation module 101 may provide omnidirectional movement capability independent of the vehicle's drivetrain configuration, eliminating the need for transmission manipulation during relocation operations.

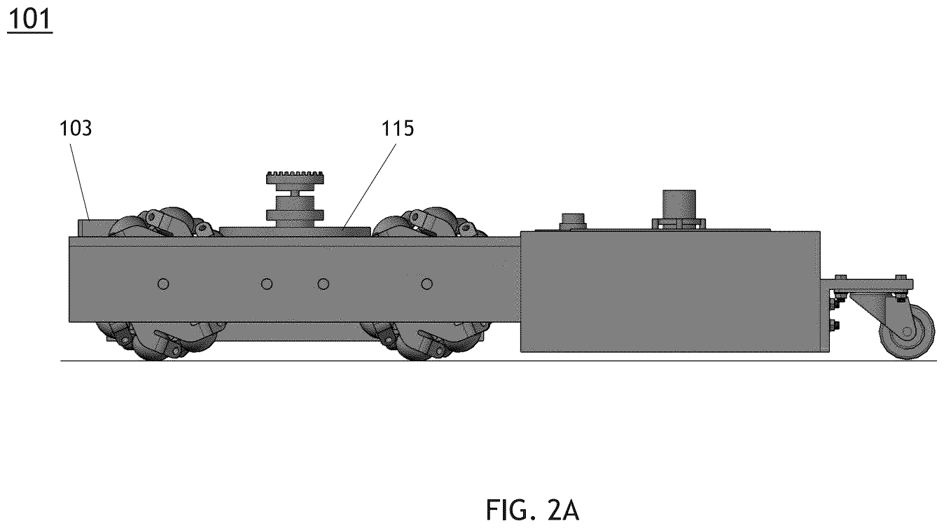

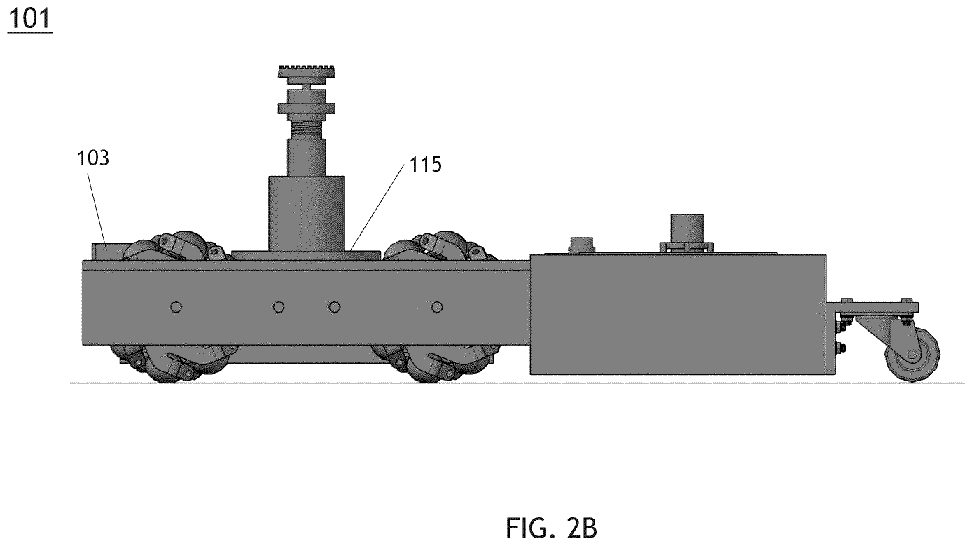

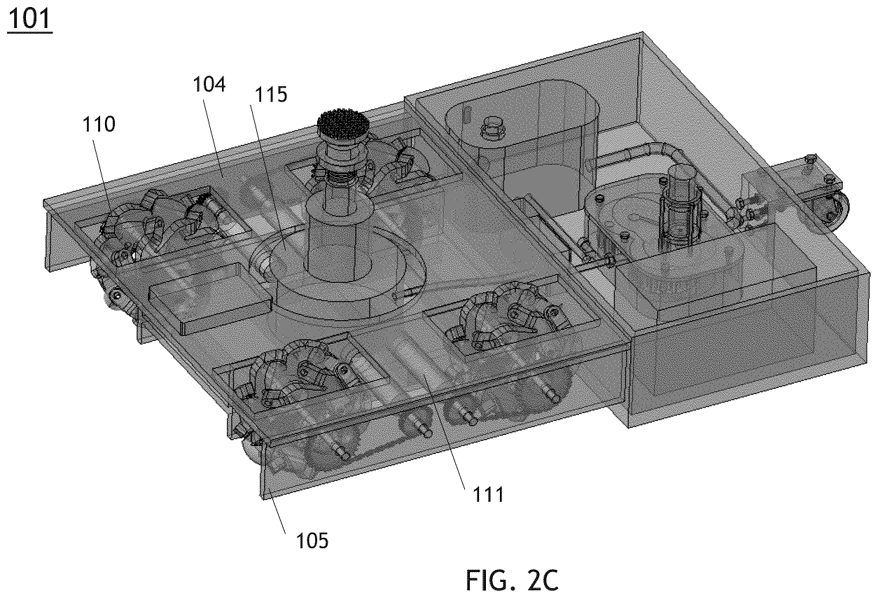

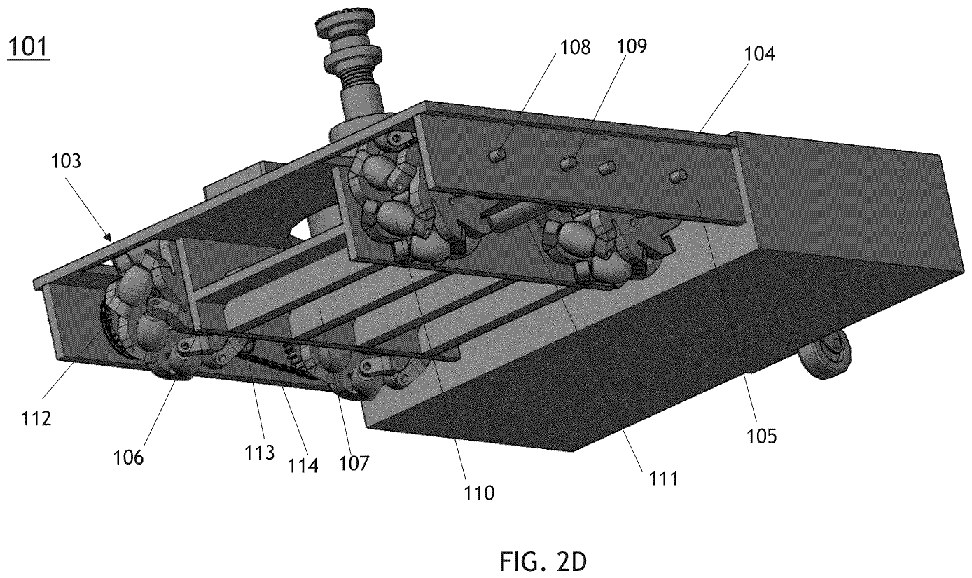

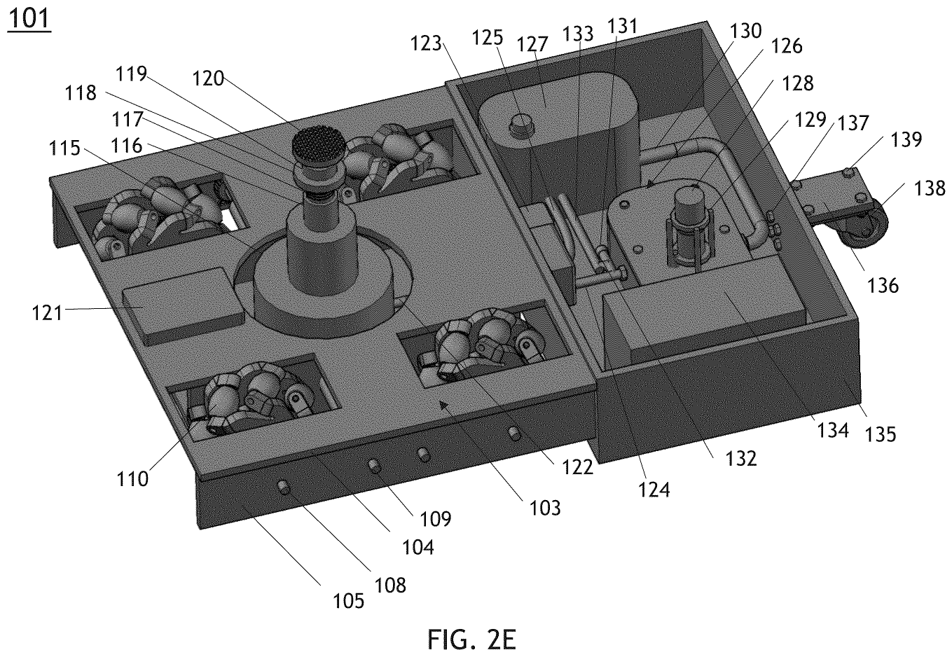

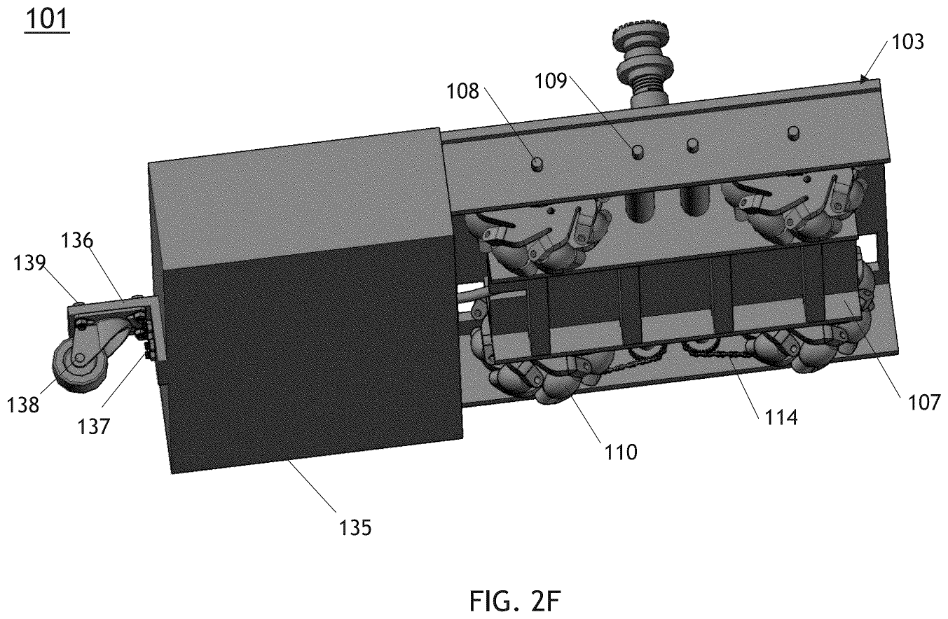

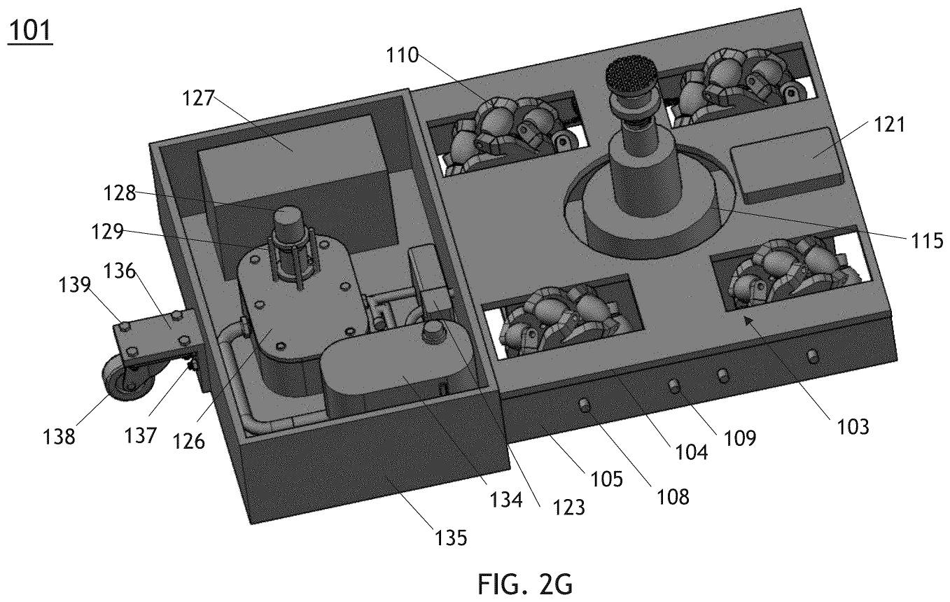

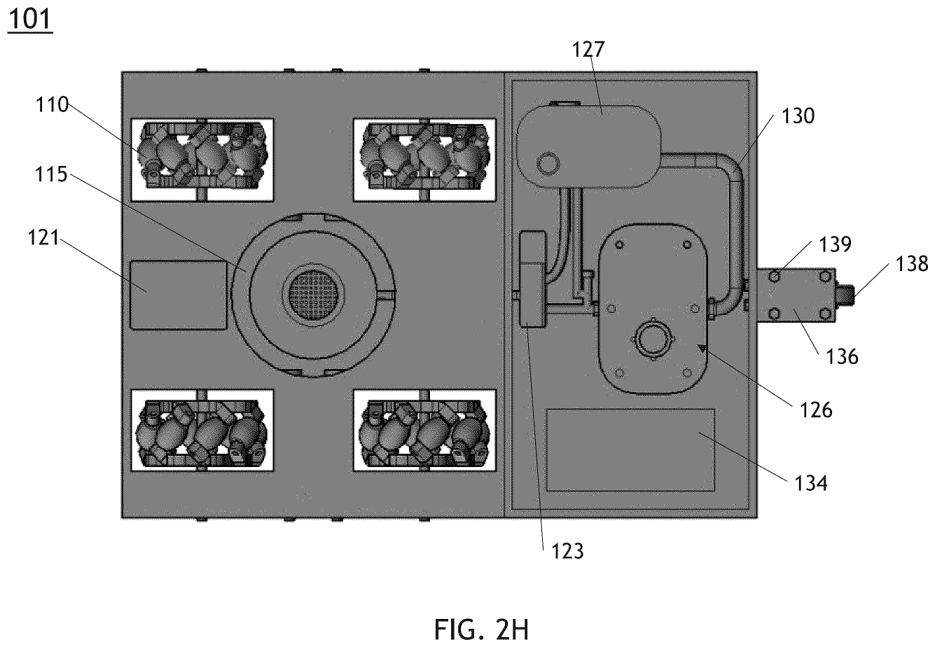

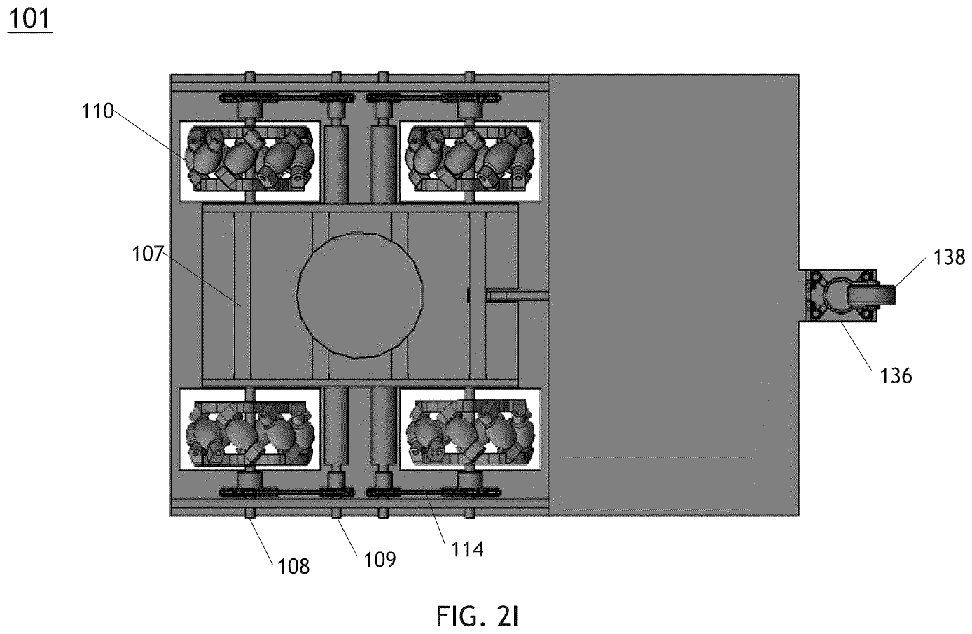

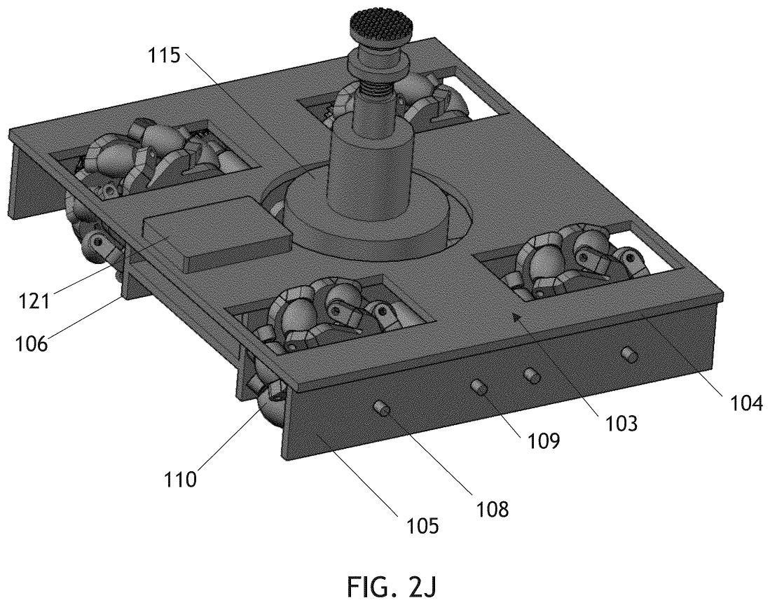

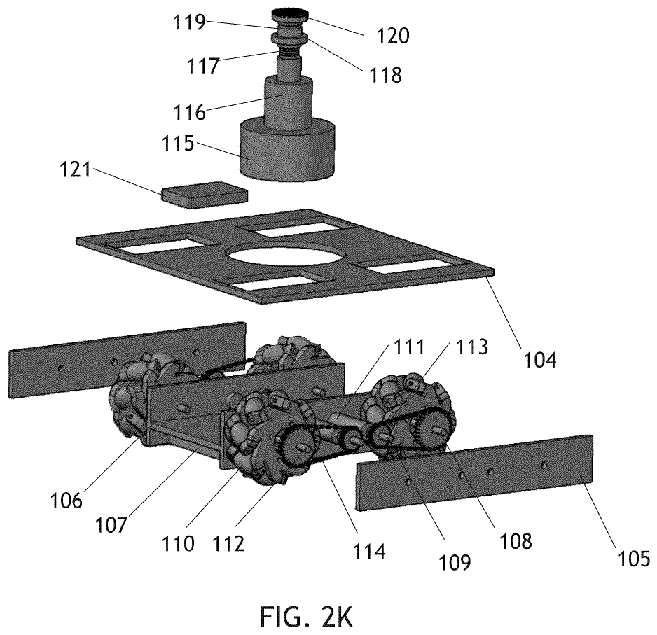

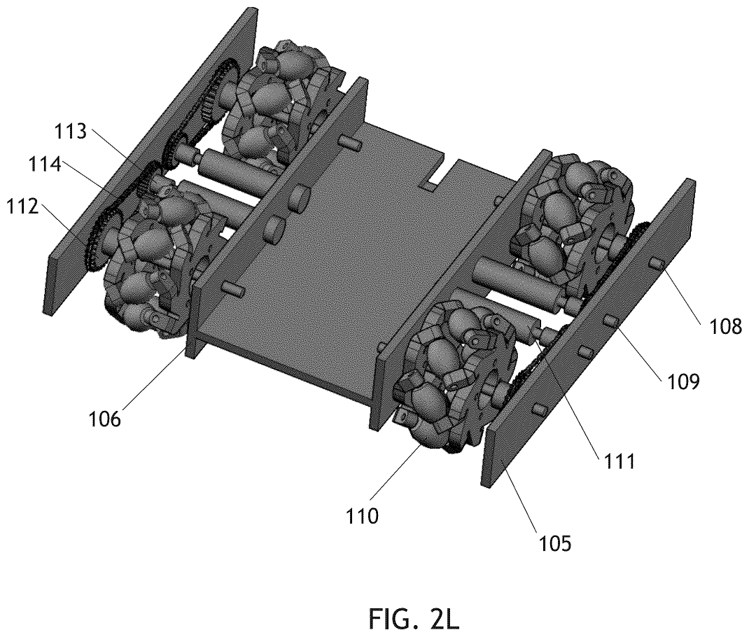

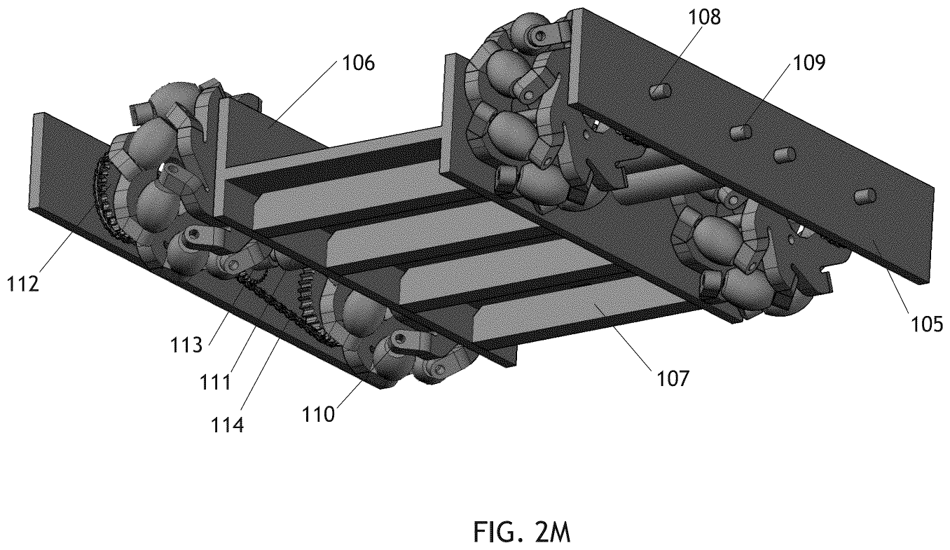

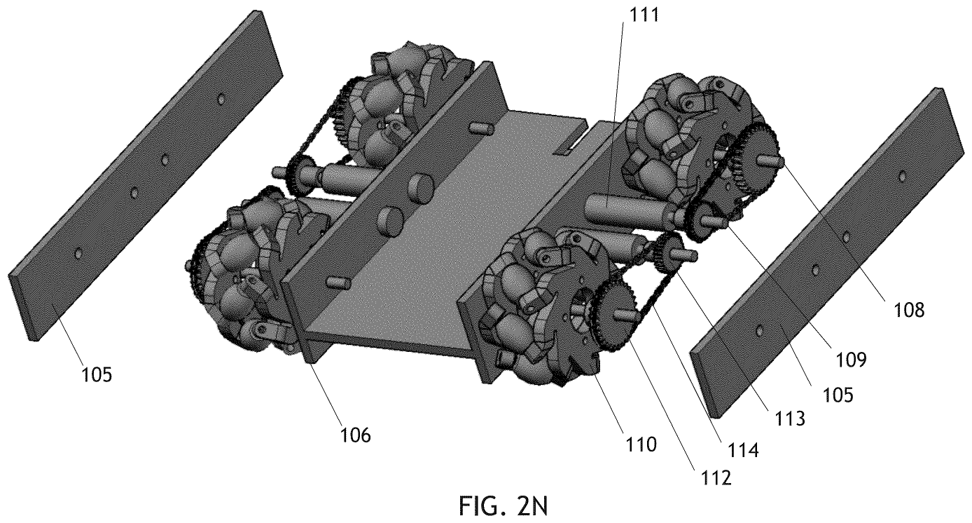

FIGS. 2A-2B illustrate the relocation module 101 in different operational states, in accordance with one or more embodiments of the present disclosure. In particular, FIG. 2A is an elevational view of the relocation module 101 prior to hydraulic extension and FIG. 2B is an elevational view of the relocation module 101 following hydraulic extension.

In embodiments, the relocation module 101 may be positioned in at least one of a retracted state (as shown in FIG. 2A) or an extended state (as shown in FIG. 2B). The relocation module 101 may include a chassis 103 configured to fit beneath vehicle pinch-weld jacking points.

In embodiments, the overall minimum height of the relocation module 101 may be configured to fit beneath standard vehicles at pinch weld locations without requiring preliminary elevation of the vehicle. For example, the overall minimum height of the relocation module 101 before actuation may range from approximately 3 inches to approximately 7 inches, depending on the specific application and vehicle clearance requirements. In a non-limiting example, the overall minimum height may be approximately 5 inches before actuation, enabling positioning beneath vehicles with limited ground clearance, including sedans, SUVs, minivans, and electric vehicles.

In embodiments, the relocation module 101 may include a hydraulic jack 115 (e.g., single-acting hydraulic jack) with a four-stage telescopic cylinder mounted to the chassis 103. The telescopic cylinder may be configured to extend a predetermined distance to lift the inoperable vehicle. For example, the telescopic cylinder may extend in a range from approximately 4 inches to approximately 12 inches, depending on the specific application and vehicle type requirements. In a non-limiting example, the telescopic cylinder may extend up to approximately 8 inches, providing sufficient vertical displacement to elevate vehicle tires above the ground surface for subsequent omnidirectional movement operations. Referring to FIG. 2B, the relocation module 101 in the extended configuration may lift various vehicle types, including sedans, SUVs, minivans, and electric vehicles. The chassis may transfer vehicle load from the hydraulic jack through the chassis structure to the mecanum wheels during the extended configuration.

FIG. 2C illustrates an isometric, transparent view of the relocation module 101 with the hydraulic jack in an extended state, in accordance with one or more embodiments of the present disclosure. The transparent rendering allows visualization of the internal components and their spatial relationships within the relocation module 101.

In embodiments, the chassis 103 may include a top plate 104 and two vertical edge plates 105. The top plate 104 may form the upper surface of the chassis 103 and may include an opening positioned centrally to accommodate a hydraulic jack assembly, as well as one or more cutouts aligned with positions of a plurality of mecanum wheels 110. The two vertical edge plates 105 may extend downward from opposite edges of the top plate 104 and may contain multiple holes configured to receive axles for mounting the mecanum wheels 110 and the drive motors 111.

In embodiments, the relocation module 101 may include a plurality of mecanum wheels 110 mounted to the chassis 103 and configured to enable omnidirectional movement. As used herein, “omnidirectional movement” refers to the capability to move in any direction within a horizontal plane, including forward, backward, lateral (e.g., left and right), diagonal, and rotational movements, without requiring reorientation of the vehicle or the relocation module 101. For example, the relocation module 101 may include four mecanum wheels 110 positioned at the four corners of the relocation module 101. Each mecanum wheel 110 may be driven by a respective electric motor 111 through a chain drive assembly, enabling independent control of wheel rotation for omnidirectional movement capability.

FIGS. 2D-2N illustrate various views of the relocation module 101, including the chassis 103, drive system components, and hydraulic jack assembly, in accordance with one or more embodiments of the present disclosure.

In embodiments, the chassis 103 may further include a platform 106 and a plurality of vertical stiffeners 107. The platform 106 may be an H-shaped platform (e.g., having two parallel longitudinal members connected by a central cross member) positioned below the top plate 104 and configured to distribute loads from the hydraulic jack 115 to the wheel axles. The vertical stiffeners 107 may be attached to the platform 106 and configured to transfer load from the hydraulic jack 115 to the mecanum wheels 110.

In embodiments, the mecanum wheels 110 may be mounted to the chassis 103 via exterior axles 108 and interior axles 109, which pass through holes in the vertical edge plates 105. Each exterior axle 108 may support a mecanum wheel 110 and a large sprocket 112 mounted adjacent to the wheel. Each interior axle 109 may be coupled to an electric motor 111 and a small sprocket 113. Each mecanum wheel 110 may be driven by a respective electric motor 111 through a chain drive assembly including the large sprocket 112 and the small sprocket 113 connected by a chain 114. The chain drive assembly may convert high-speed rotation from the electric motor 111 into high-torque output, enhancing load capacity and drive reliability for high-weight vehicles.

The mecanum wheels 110 may have a diameter ranging from approximately 2 inches to approximately 12 inches, depending on the specific application and load requirements. For example, the mecanum wheels 110 may have a diameter of approximately 4 inches for standard applications. For vehicles with higher jacking clearance or increased weight, mecanum wheels 110 of larger diameter may be used. Additional mecanum wheels 110 may be mounted side-by-side on each axle to distribute vehicle weight more evenly across a larger contact area. It is contemplated herein that extra wheel axles may be added to enhance load distribution, and that the number, size, and arrangement of mecanum wheels 110 may be varied based on the specific vehicle type, weight capacity requirements, and operational environment. It is further contemplated that two odometry wheels with encoders may be used to localize each relocation module 101 and allow dynamic trajectory adjustments for autonomous movement, and that standard non-mecanum wheels may be used in place of mecanum wheels 110 for applications where omnidirectional movement is not required.

In embodiments, the hydraulic jack 115 may be centrally positioned on the chassis 103 and extend vertically through the circular opening in the top plate 104. The hydraulic jack 115 may include a ram 116, an extension screw 117, a bearing plate 118, a load cell 119, and a saddle 120 positioned at the top. The load cell 119 may be positioned between the bearing plate 118 and the saddle 120 and configured to detect vehicle lift-off and measure distributed vehicle weight, transmitting real-time feedback to a local computer for load monitoring and automatic jacking control.

In embodiments, the saddle 120 may have a contact surface configured to engage a vehicle jacking point. The contact surface may include one or more surface features configured to enhance engagement with the vehicle jacking point. For instance, the contact surface may be textured, patterned, roughened, or otherwise modified to improve grip and load distribution. By way of example, the saddle 120 may have a grooved, dimpled, knurled, ribbed, serrated, or otherwise contoured contact surface to center the load, distribute force evenly, and improve friction to prevent slippage during lifting operations. It is contemplated herein that the contact surface may include any suitable configuration, material, or treatment that facilitates secure engagement with vehicle jacking points including, but not limited to, rubber coatings, elastomeric pads, friction-enhancing materials, or combinations thereof.

In embodiments, the relocation module 101 may include a control box 121 mounted on the top plate 104. The control box 121 may house control electronics for coordinating jack and wheel operations, including a local computer configured to control the hydraulic jack 115 and the mecanum wheels 110. The local computer may include an analog-to-digital converter (ADC) configured to process signals from the load cell 119, a relay driver configured to control a directional control valve, and a power supply configured to provide electrical power to system components. For instance, the local computer may be a Raspberry Pi microcomputer, an Arduino microcontroller, a programmable logic controller (PLC), a field-programmable gate array (FPGA), or any other suitable embedded computing device capable of processing sensor inputs and controlling actuators in real-time.

In embodiments, the hydraulic jack 115 may be connected to a hose 122, which links to a directional control valve 123. The directional control valve 123 may be a 3/2-way solenoid-actuated directional control valve including three ports (a pressure port, an actuator port, and a tank port) and two switching positions. The directional control valve 123 may be fluidly coupled between the hydraulic jack 115 and a gear pump 126, and may include a first hose 124 and a second hose 125, which provide fluid communication with the gear pump 126 and an oil reservoir 127, respectively. The gear pump 126 may be operatively coupled to an electric motor 128 mounted on a motor support 129, which may consist of two ring plates and four welded wire posts. A hose 130 may connect the gear pump 126 to the oil reservoir 127, establishing a fluid circulation path.

In embodiments, the relocation module 101 may include a pressure relief valve 131 connected between the gear pump 126 and the oil reservoir 127 and configured to prevent overpressure conditions. The pressure relief valve 131 may be connected to a hydraulic hose fitting 132, which links to the oil reservoir 127 via a hose 133. In some instances, an optional pressure gauge may be included to provide real-time monitoring and allow for safe manual adjustments.

In embodiments, a power supply 134 may provide electrical power to the electric motor 128 and other electronic components within the relocation module 101. A pump control box 135 may be secured to the chassis 103 and may house hydraulic control components. The pump control box 135 may be connected to a bracket 136 via bolts 137. The bracket 136 may be attached to a swivel caster 138 using bolts 139. The swivel caster 138 may provide mobility when the hydraulic jack 115 is not engaged with a vehicle.

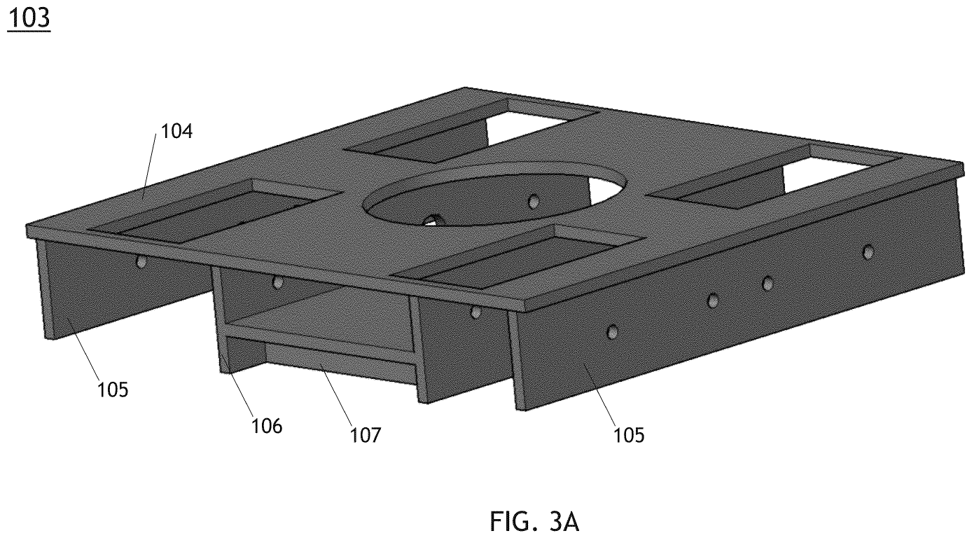

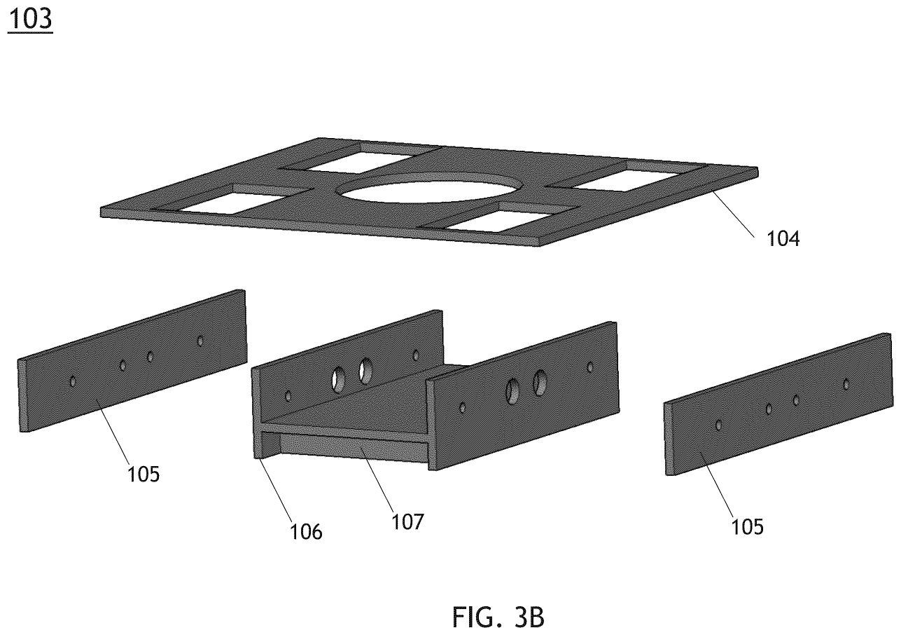

FIGS. 3A-3B illustrate the chassis 103 that supports the hydraulic jack, in accordance with one or more embodiments of the present disclosure.

Referring to FIG. 3A, in embodiments, the top plate 104 may include a central circular opening configured to accommodate the hydraulic jack, as well as rectangular cutouts positioned near the corners aligned with the positions of the mecanum wheels. Each vertical edge plate 105 may contain multiple holes configured to accommodate axles for mounting the mecanum wheels and drive motors.

With continued reference to FIG. 3A, in embodiments, the platform 106 may feature a horizontal configuration with two parallel longitudinal members connected by a central cross member, forming an H-shape when viewed from above. The plurality of vertical stiffeners 107 may be distributed across the platform 106 to ensure even load distribution during jacking operations.

Referring to FIG. 3B, in embodiments, the exploded view illustrates the spatial relationship and assembly sequence of the components that form the chassis 103. The top plate 104 may provide a mounting surface for the hydraulic jack assembly and define the upper boundary of the chassis structure. The two vertical edge plates 105 may establish the mounting points for the wheel assemblies through the multiple holes contained therein. The arrangement of the vertical stiffeners 107 may enable the chassis 103 to support the vehicle weight transferred through the hydraulic jack while maintaining stability during lifting and movement operations.

In embodiments, the chassis 103 may be assembled using welded connections between the top plate 104 and the vertical edge plates 105, and between the top plate 104 and the platform 106. Alternatively, bolted connections may be used with added steel angles for easier maintenance. The steel angles may provide additional structural support at connection points while enabling non-permanent fastening of the chassis components.

In embodiments, the chassis 103 may provide structural integrity and load distribution for the relocation module, enabling the transfer of vehicle weight from the hydraulic jack through the chassis structure to the mecanum wheels. The arrangement of the top plate 104, vertical edge plates 105, platform 106, and vertical stiffeners 107 may establish a load path that distributes forces from the hydraulic jack to the wheel axles during lifting operations.

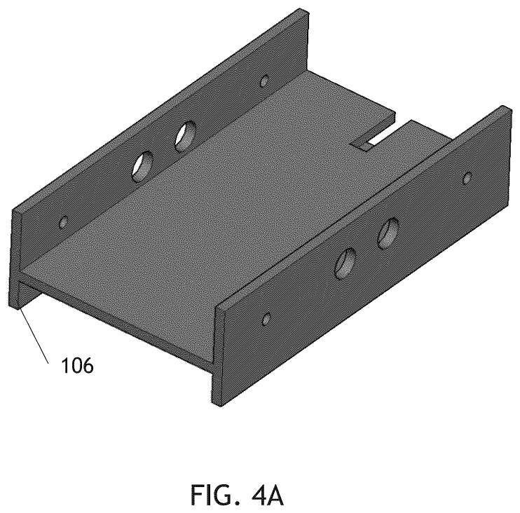

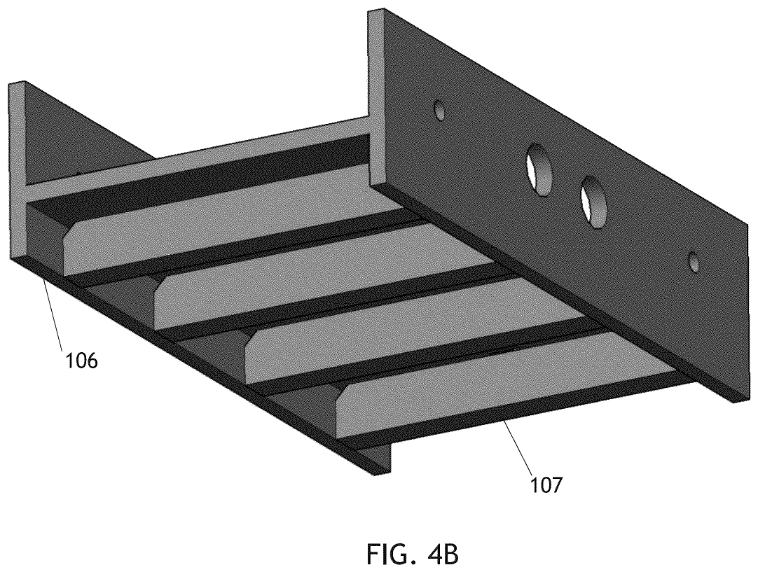

FIGS. 4A-4B illustrate the platform 106 forming part of the jack-supporting chassis, in accordance with one or more embodiments of the present disclosure. In particular, FIG. 4A is an isometric top view of the platform 106 and FIG. 4B is an isometric bottom view of the platform 106. Referring to FIG. 4A, in embodiments, one side of the horizontal plate may include a slot configured to route a hose to the control valve. The platform 106 may include multiple mounting holes for attachment to other chassis components and for securing the hydraulic jack assembly. Referring to FIG. 4B, in embodiments, the bottom view of the platform 106 reveals the plurality of vertical stiffeners 107 attached to the bottom surface. The arrangement of the vertical stiffeners 107 may provide structural reinforcement and ensure even load distribution during jacking operations.

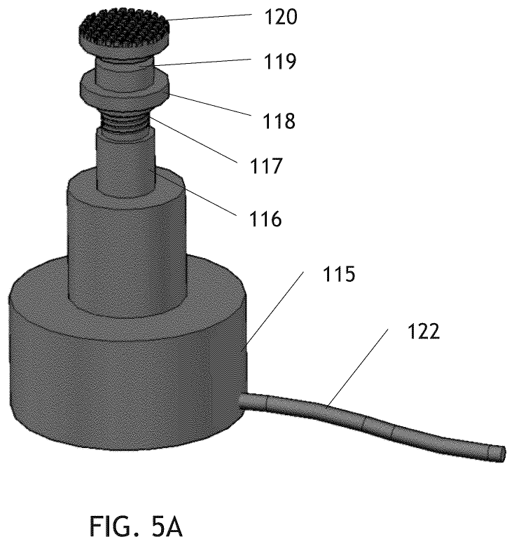

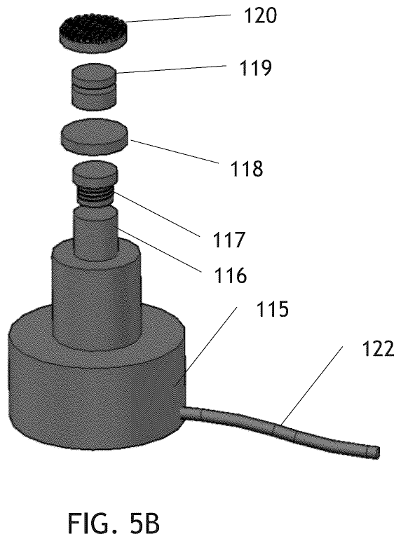

FIGS. 5A-5B illustrate the hydraulic jack 115, in accordance with one or more embodiments of the present disclosure.

Referring to FIG. 5A, in embodiments, the hydraulic jack 115 may include a ram 116, an extension screw 117, a bearing plate 118, a load cell 119, a saddle 120, and a hose 122. The ram 116 may form the base cylinder of the telescopic assembly. The extension screw 117 may be positioned at the upper portion of the ram 116, providing threaded adjustment capability. The bearing plate 118 may be mounted above the extension screw 117, serving as a load-bearing surface. The load cell 119 may be positioned on top of the bearing plate 118, configured to measure the force applied during lifting operations. The saddle 120 may be mounted at the top of the assembly, featuring a textured surface with grooves or dimples to center the load, distribute force evenly, and improve friction to prevent slippage during operation. The hose 122 may extend from the side of the hydraulic jack 115, providing fluid communication between the hydraulic jack 115 and the hydraulic control system.

As previously discussed herein, the hydraulic jack 115 may include a four-stage telescopic cylinder design that enables vertical extension for lifting applications while maintaining a compact profile when retracted. The four-stage configuration may provide a stroke length ranging from approximately 4 inches to approximately 12 inches. In a non-limiting example, the four-stage telescopic cylinder may extend up to approximately 8 inches, providing sufficient lift height for various vehicle types including sedans, SUVs, minivans, and electric vehicles.

Referring to FIG. 5B, in embodiments, the exploded view illustrates the spatial relationship and assembly sequence of the components that form the hydraulic jack 115. The extension screw 117 may provide threaded adjustment capability for fine-tuning the vertical extension of the jack assembly. The bearing plate 118 may distribute forces during lifting operations.

With continued reference to FIG. 5B, in embodiments, the load cell 119 may provide real-time feedback to the local computer for accurate detection of tire lift-off and load monitoring during jacking operations. The load cell 119 may detect peak load during the lifting sequence, and the system 100 may automatically halt jacking once the load is held for a preset time. For example, the preset time may be approximately 5 seconds. This automatic halting feature may prevent over-extension of the hydraulic jack 115 and may ensure that the vehicle is lifted to an appropriate height without excessive force application.

In embodiments, the hose 122 may connect the hydraulic jack 115 to the directional control valve, enabling pressurized fluid delivery for jack extension and fluid return during retraction.

In embodiments, the hydraulic jack 115 may include sealing components to maintain fluid integrity under pressure. For example, a gasket or O-rings may be placed between a pump lid and pump case to ensure a fluid-tight seal under pressure. The sealing components may prevent hydraulic fluid leakage during operation and may maintain system pressure for consistent lifting performance.

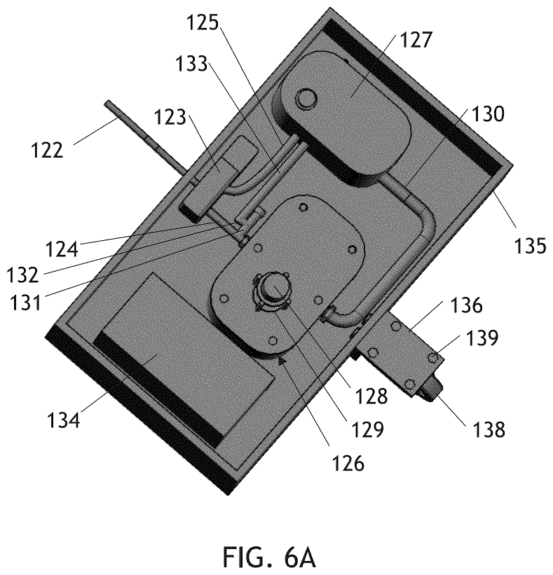

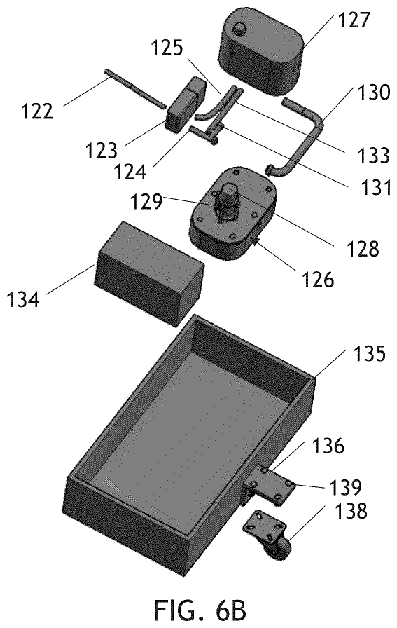

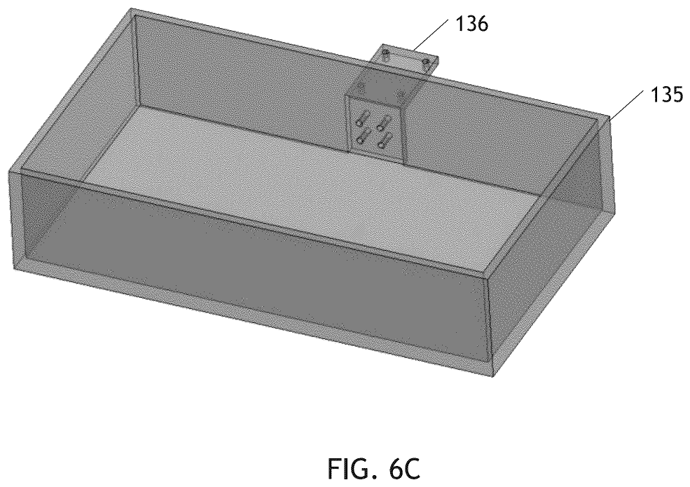

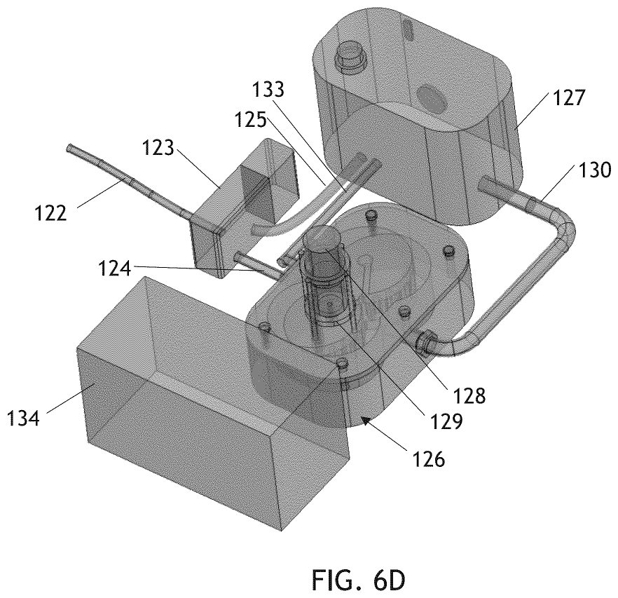

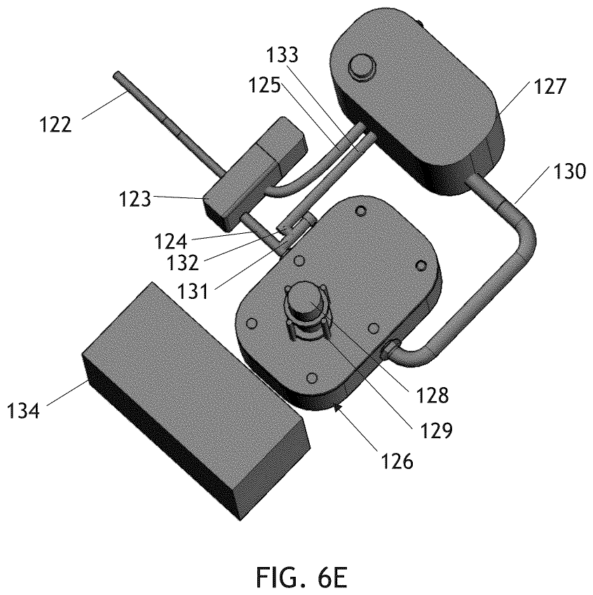

FIGS. 6A-6E illustrate the hydraulic control box assembly and hydraulic control components, in accordance with one or more embodiments of the present disclosure.

Referring to FIG. 6A, in embodiments, the pump control box 135 may be mounted on the swivel caster 138 along with additional hydraulic control components. The pump control box 135 may be attached to the bracket 136 via bolts 139, and the bracket 136 may be secured to the swivel caster 138. The arrangement of the pump control box 135 and swivel caster 138 may provide mobility to the relocation module when the hydraulic jack is not engaged with a vehicle, enabling repositioning of the module during setup operations.

In embodiments, the hydraulic control components housed within and around the pump control box 135 may include the directional control valve 123, the gear pump 126, the oil reservoir 127, the electric motor 128, the motor support 129, the power supply 134, and the pressure relief valve 131. The directional control valve 123 may be connected to the hose 122, the first hose 124, and the second hose 125. The gear pump 126 may be operatively coupled to the electric motor 128, which may be mounted on the motor support 129. The hose 130 may provide fluid communication between the gear pump 126 and the oil reservoir 127. The pressure relief valve 131 may be connected to the hydraulic hose fitting 132, which may link to the oil reservoir 127 via the hose 133. The power supply 134 may provide electrical power to the electric motor 128 and other electrical components within the system. The arrangement of these components within and around the pump control box 135 may enable compact integration of the hydraulic control system while maintaining accessibility for maintenance and operation.

Referring to FIG. 6B, in embodiments, the bracket 136 may have a perpendicular configuration with two planar sections joined at a right angle, providing a mounting interface between the pump control box 135 and the swivel caster 138.

Referring to FIG. 6C, in embodiments, the pump control box 135 may be an enclosure configured to house hydraulic control components. The pump control box 135 may have any suitable shape including, but not limited to, rectangular, square, cylindrical, or other geometric configurations adapted to the spatial constraints of the relocation module. The pump control box 135 may include multiple holes drilled through surfaces thereof for securing the enclosure to other components of the relocation module. The transparent rendering reveals the internal volume of the pump control box 135, which may provide space for accommodating the directional control valve, the gear pump, the oil reservoir, the electric motor, and associated hydraulic hoses.

In embodiments, the bracket 136 may include multiple holes configured to receive bolts for securing the bracket to both the pump control box 135 and the swivel caster. The bracket 136 may provide a mounting interface that enables attachment of the swivel caster to the pump control box 135, thereby providing mobility to the relocation module when the hydraulic jack is not engaged with a vehicle.

Referring to FIG. 6D, in embodiments, the transparent rendering allows visualization of the internal arrangement and spatial relationships of the hydraulic control components within the assembly. The power supply 134 may be positioned adjacent to the motor support 129 and may provide electrical power to the electric motor 128 for driving the gear pump 126.

In embodiments, the hose 124 may connect the directional control valve 123 to the gear pump 126, providing a fluid path for pressurized hydraulic fluid delivery. The hose 125 may connect the directional control valve 123 to the oil reservoir 127, enabling fluid return during jack retraction operations.

In embodiments, the oil reservoir 127 may store hydraulic fluid for the system and may serve as a connection point for multiple hoses. The hose 130 may provide fluid communication between the gear pump 126 and the oil reservoir 127, establishing a fluid circulation path for drawing hydraulic fluid into the pump during jack extension operations. The hose 133 may connect the oil reservoir 127 to the pressure relief valve via the hydraulic hose fitting, providing a fluid return path when system pressure exceeds a predetermined threshold.

Referring to FIG. 6E, in embodiments, the directional control valve 123 may regulate the flow of hydraulic fluid between the gear pump 126, the hydraulic jack, and the oil reservoir 127 to control jack extension and retraction operations.

In embodiments, the pressure relief valve 131 may be configured to reduce pressure when system pressure exceeds a specified limit, protecting the hydraulic system from overpressure conditions by diverting excess fluid back to the oil reservoir 127.

In embodiments, the oil reservoir 127 may receive fluid from the directional control valve 123 during jack retraction and may supply fluid to the gear pump 126 during jack extension operations.

In embodiments, the power supply 134 may enable the electric motor 128 to generate the rotational force for the gear pump 126 to pressurize hydraulic fluid for jack extension.

In embodiments, the arrangement of the hydraulic control components may enable controlled extension and retraction of the hydraulic jack through coordinated operation of the electric motor 128, the gear pump 126, and the directional control valve 123, with fluid management provided by the oil reservoir 127 and the associated hose connections.

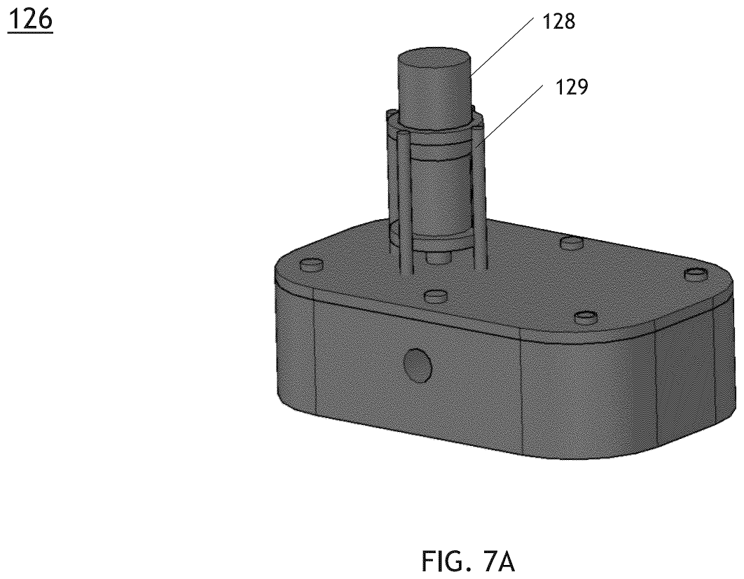

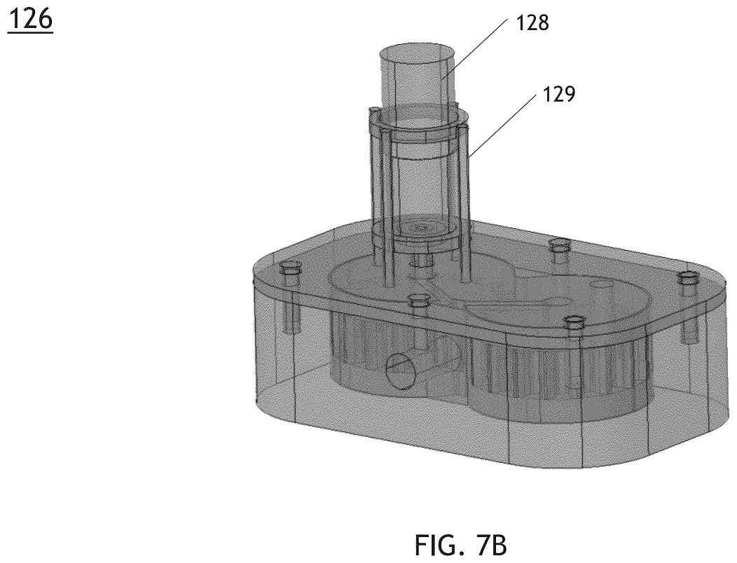

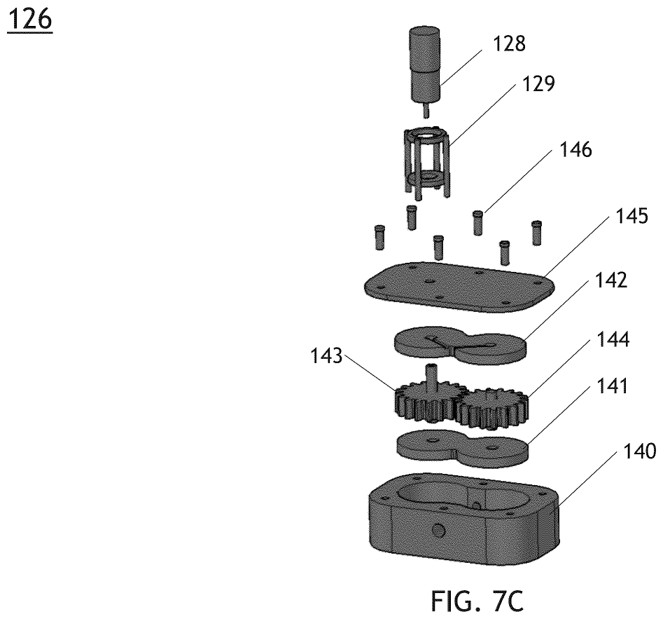

FIGS. 7A-7C illustrate the gear pump 126, the electric motor 128, and the motor support 129 assembly, in accordance with one or more embodiments of the present disclosure.

In embodiments, the electric motor 128 may be operatively coupled to the gear pump 126, providing rotational power to drive the pump mechanism for generating pressurized hydraulic fluid. The motor support 129 may be positioned between the electric motor 128 and the gear pump 126, providing structural support for mounting the electric motor 128 and gear pump 126 assembly. The motor support 129 may consist of two ring plates connected by four welded wire posts, maintaining proper alignment between the motor shaft and the pump mechanism. This assembly configuration may enable the electric motor 128 to drive the gear pump 126, which may supply pressurized hydraulic fluid for jack extension operations within each relocation module 101. The arrangement of the gear pump 126, the electric motor 128, and the motor support 129 may provide a compact drive assembly that fits within the spatial constraints of the relocation module 101 while delivering sufficient hydraulic pressure for vehicle lifting operations.

The electric motor 128 may include a cylindrical housing and shaft extending toward the gear pump 126. The motor support 129 may maintain the spatial relationship between the electric motor 128 and the gear pump 126, ensuring proper coupling and alignment during operation.

In embodiments, the gear pump 126 may include a pump case 140, which may form the main housing of the pump assembly. The pump case 140 may include a pressure port on a front face and a suction port on a back face for fluid communication with the hydraulic system. A bottom support bearing 141 may be positioned within the pump case 140 adjacent to gearing components. A top support bearing 142 may be positioned above the bottom support bearing 141, with a leakage path provided on an inlet side of the top support bearing 142.

In embodiments, the gearing mechanism may include a drive gear 143 and an idle gear 144 positioned between the bottom support bearing 141 and the top support bearing 142. The drive gear 143 may be coupled to the electric motor 128 and may transmit rotational motion to the idle gear 144, creating the pumping action that pressurizes hydraulic fluid for jack extension operations.

In embodiments, a pump lid 145 may be positioned at the bottom of the assembly and may be configured to enclose the pump case 140. The pump lid 145 may be secured to the pump case 140 using threaded bolts 146. A gasket or O-rings may be placed between the pump lid 145 and the pump case 140 to ensure a fluid-tight seal under pressure during operation.

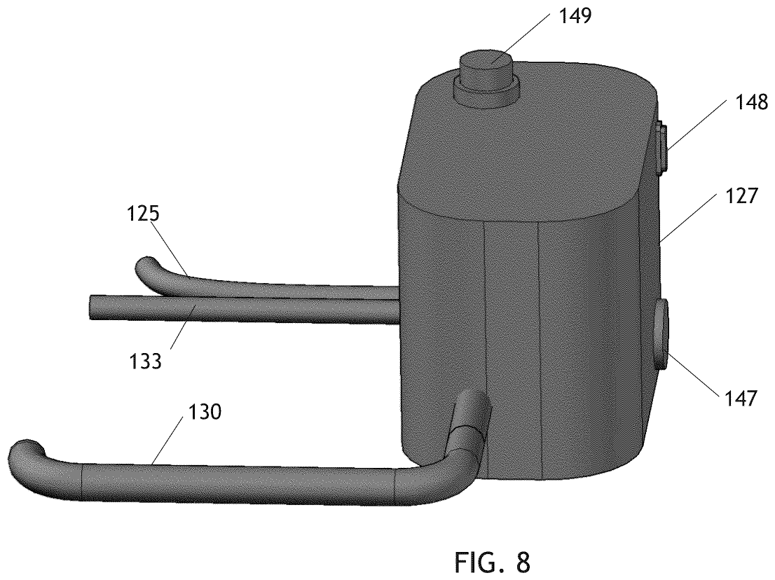

FIG. 8 illustrates the oil reservoir 127, in accordance with one or more embodiments of the present disclosure.

In embodiments, the oil reservoir 127 may be configured to store hydraulic fluid for the hydraulic system and may serve as a connection point for multiple hoses that facilitate fluid circulation within each relocation module 101.

In embodiments, the oil reservoir 127 may include a drain plug 147 positioned at a lower portion of the reservoir body. The drain plug 147 may be configured to enable removal of hydraulic fluid from the oil reservoir 127 for maintenance or fluid replacement operations.

In embodiments, an oil level indicator 148 may be mounted on a side of the oil reservoir 127. The oil level indicator 148 may be configured to provide visual indication of the hydraulic fluid level within the reservoir, enabling operators to monitor fluid levels and ensure adequate fluid supply for system operation.

In embodiments, a cap 149 may be positioned at a top of the oil reservoir 127. The cap 149 may provide access to the interior of the oil reservoir 127 for adding hydraulic fluid and may include venting capability to accommodate fluid volume changes during system operation.

In embodiments, the oil reservoir 127 may include multiple hose connections for fluid communication with other hydraulic system components. The hose 125 may extend from the oil reservoir 127 and may connect to the directional control valve 123, providing a fluid return path during jack retraction operations. The hose 130 may connect the oil reservoir 127 to the gear pump 126, establishing a fluid supply path for drawing hydraulic fluid into the pump during jack extension operations. The hose 133 may connect the oil reservoir 127 to the pressure relief valve 131 via the hydraulic hose fitting 132, providing a fluid return path when system pressure exceeds a predetermined threshold.

In embodiments, the arrangement of the drain plug 147, the oil level indicator 148, the cap 149, and the hose connections on the oil reservoir 127 may enable fluid management, monitoring, and maintenance of the hydraulic system within each relocation module 101.

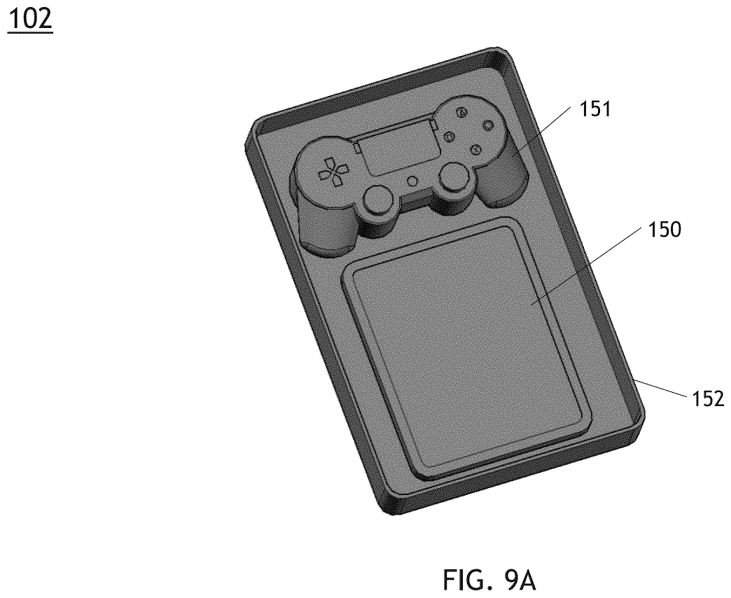

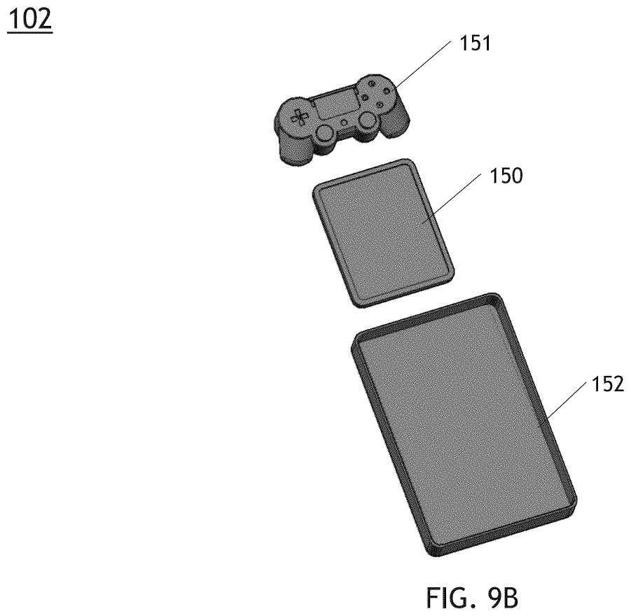

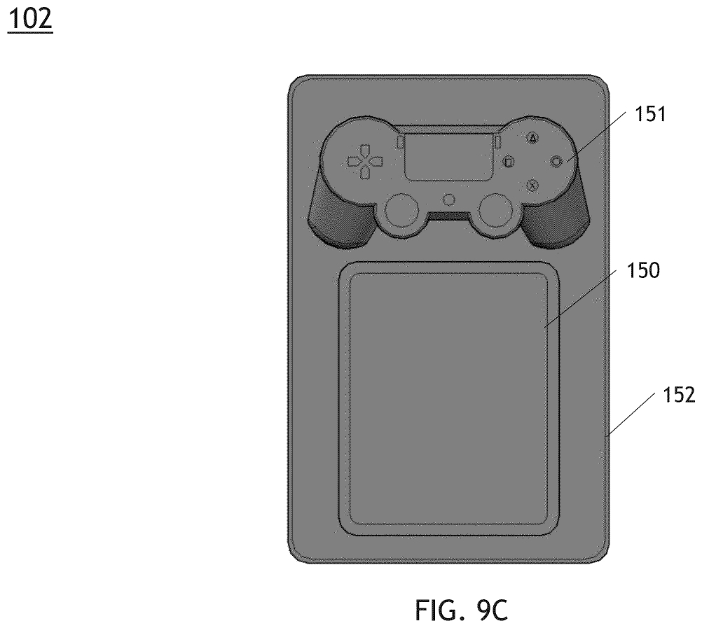

FIGS. 9A-9C illustrate the central control unit 102, in accordance with one or more embodiments of the present disclosure.

In embodiments, the central control unit 102 may include a central computer 150, a wireless human machine interface 151, and a control unit case 152. The central control unit 102 may provide the primary control hub for coordinating operations across the plurality of relocation modules 101 through wireless communication.

In embodiments, the control unit case 152 may be an enclosure configured to house and protect the central computer 150 and the wireless human machine interface 151 during transport and operation. The control unit case 152 may include a recessed interior with shaped compartments configured to accommodate the components in an organized arrangement. The control unit case 152 may provide a portable housing structure that enables transportation of the central control unit 102 alongside the relocation modules 101.

In embodiments, the wireless human machine interface 151 may be positioned within the control unit case 152 and may resemble a gaming controller. The wireless human machine interface 151 may be configured to communicate with the central computer 150 via Bluetooth connectivity, enabling an operator to issue control commands for coordinated actuation across all relocation modules 101. The wireless human machine interface 151 may provide real-time control of vehicle lifting and movement functions through joystick inputs and command buttons.

In embodiments, the central computer 150 may be positioned within the control unit case 152 adjacent to the wireless human machine interface 151. The central computer 150 may be configured to receive inputs from the wireless human machine interface 151 and coordinate operations across the relocation modules 101 through wireless communication with local computers in each relocation module 101. The central computer 150 may process operator inputs and transmit synchronized instructions for integrated control of jacking and omnidirectional movement operations.

The control unit case 152 may be positioned at the base of the assembly, with the wireless human machine interface 151 and the central computer 150 positioned above the control unit case 152 in the exploded arrangement.

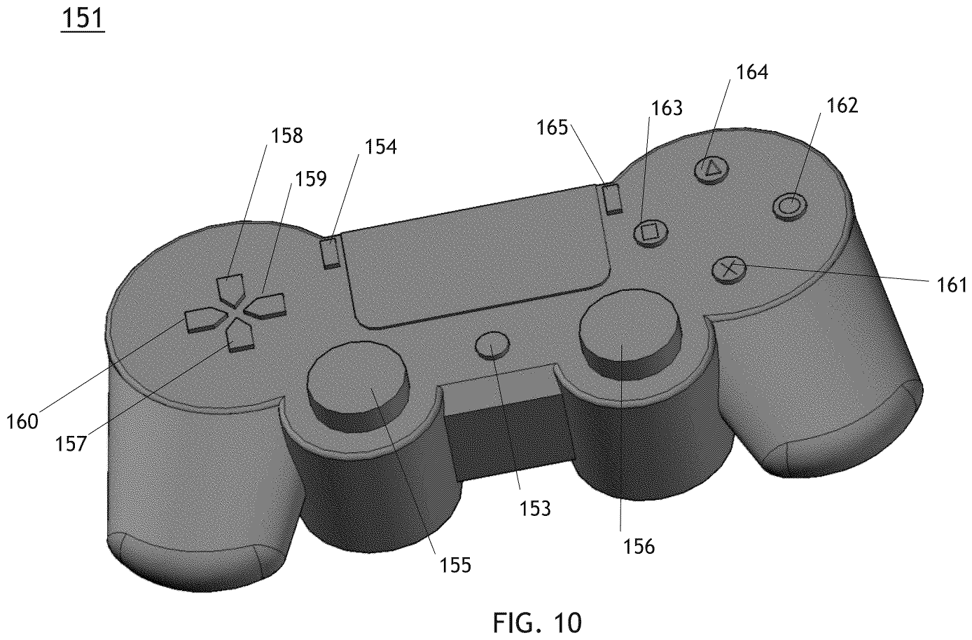

FIG. 10 illustrates the wireless human machine interface (HMI) 151, in accordance with one or more embodiments of the present disclosure.

In embodiments, the wireless human machine interface 151 may include multiple input controls distributed across a surface thereof for operator interaction with the relocation system 100. For example, the wireless human machine interface 151 may include a left stick 155 positioned on a left side of the controller and a right stick 156 positioned on a right side of the controller. In a non-limiting example, the left stick 155 may provide smooth proportional control of translational movement in forward, backward, left, and right directions by coordinating wheel speeds across all relocation modules 101. Further, continuing with the above example, the right stick 156 may adjust jack height across all relocation modules 101, allowing the operator to raise or lower the vehicle 101′ incrementally. In this regard, analog signals from both the left stick 155 and the right stick 156 may be transmitted to the central computer 150, which may relay synchronized commands to the local computers within each relocation module 101. It is contemplated herein that the functions of the respective sticks may be programmed to perform different functions than described above.

In embodiments, the wireless human machine interface 151 may include a plurality of directional buttons located on a left portion of the controller. For example, the plurality of directional buttons may include a first directional button 157 (e.g., forward button), a second directional button 158 (e.g., backward button), a third directional button 159 (e.g., a left button), and a fourth directional button 160 (e.g., a right button). For example, the first directional button 157 may control mecanum wheel vectors on all relocation modules 101 to enable forward motion. By way of another example, the second directional button 158 may control mecanum wheel vectors on all relocation modules 101 to enable backward motion. By way of another example, the third directional button 159 may control mecanum wheel vectors on all relocation modules 101 to enable left motion. By way of another example, the fourth directional button 160 may control mecanum wheel vectors on all relocation modules 101 to enable right motion. It is contemplated herein that the functions of the respective buttons may be programmed to perform different functions than described above.

In embodiments, the wireless human machine interface 151 may include a plurality of face buttons positioned on a right portion of the controller. For example, the plurality of face buttons may include a first button 161, a second button 162, a third button 163, and a fourth button 164. The plurality of face buttons may include respective symbols or other identifier markers to indicate the associated function of the respective button. For example, the first button 161 may include an “X” and be configured to the hydraulic jacks 115 to raise the vehicle 101′. By way of another example, the second button 162 may include an “O” and may be configured to lower the hydraulic jacks 115 to return the vehicle 101′ to ground level. By way of another example, the third button 163 may include a square and may be configured to trigger an emergency stop and immediately halt all jacking and movement operations. By way of another example, the fourth button 164 may include a triangle and may be configured to toggle between manual and automatic operation modes or select preset jacking heights. It is contemplated herein that the functions of the respective buttons may be programmed to perform different functions than described above.

In embodiments, the wireless human machine interface 151 may include a main button 153 and a share button 154. The wireless human machine interface 151 may be paired with the central computer 150 via wireless communication by holding the main button 153 and the share button 154 at the same time. The share button 154 may additionally log current system status or send real-time alerts such as jack malfunction, obstacle detection, or low battery to the central computer 150. It is contemplated herein that the functions of the respective buttons may be programmed to perform different functions than described above.

In embodiments, the wireless human machine interface 151 may include an options button 165. The options button 165 may be configured open settings and calibration menus on the central computer 150, allowing adjustment of parameters such as jack pressure thresholds, movement speed limits, and directional sensitivity to suit operational requirements. It is contemplated herein that the functions of the respective buttons may be programmed to perform different functions than described above.

In embodiments, the relocation system 100 may communicate via any suitable wireless communication protocol between the wireless human machine interface 151 and the central computer 150, and between the central computer 150 and the local computers within each relocation module 101. For example, suitable wireless communication protocols may include, but are not limited to, Bluetooth, Bluetooth Low Energy (BLE), Wi-Fi (IEEE 802.11), Zigbee, Z-Wave, LoRa, near-field communication (NFC), radio frequency (RF) communication, infrared (IR) communication, cellular communication protocols (such as 4G LTE or 5G), or any combination thereof. It is contemplated herein that the selection of communication protocol may depend on factors including, but not limited to, range requirements, interference considerations, bandwidth requirements, and operational environment characteristics.

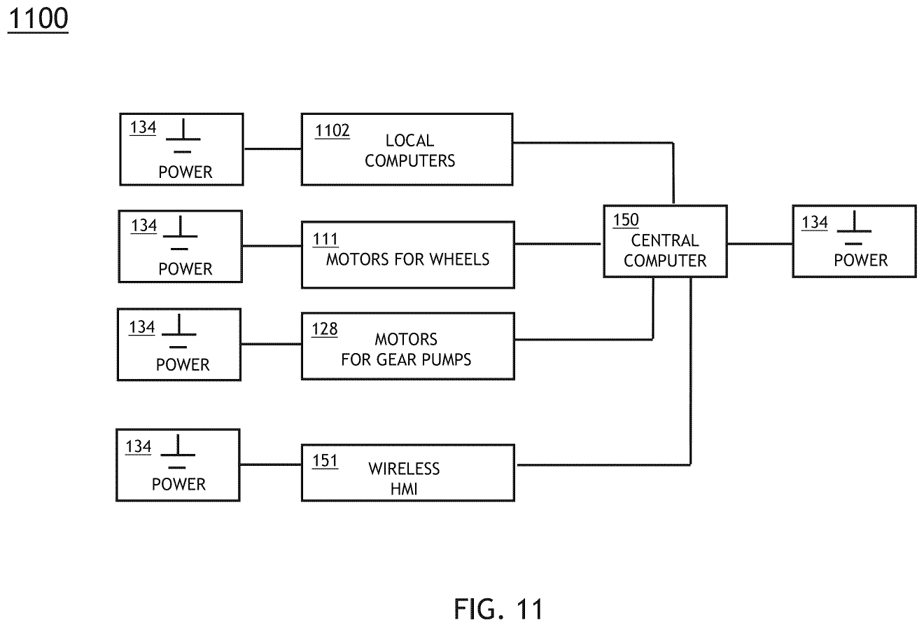

FIG. 11 illustrates a circuit diagram 1100 of the relocation system 100, in accordance with one or more embodiments of the present disclosure. In particular, the circuit diagram 1100 of FIG. 11 depicts the electrical connections and power distribution architecture for coordinating the relocation modules and central control components.

In embodiments, the central computer 150 may function as the primary control hub of the relocation system 100. The central computer 150 may be connected to a dedicated power supply 134, which may provide electrical power for control operations. The central computer 150 may receive inputs from the wireless human machine interface 151, which may be independently powered by a separate power supply 134. The wireless human machine interface 151 may transmit user commands to the central computer 150, which may then coordinate operations across the relocation system 100.

In embodiments, the central computer 150 may be communicatively coupled to local computers 1102 within each relocation module 101. Each local computer 1102 may be connected to a dedicated power supply 134, enabling distributed and reliable operation across the relocation system 100. The local computers 1102 may receive synchronized commands from the central computer 150 and may control the components within respective relocation modules 101.

In embodiments, electric motors 111 for the mecanum wheels 110 may be connected to the central computer 150 and may be independently powered by respective power supplies 134. The electric motors 111 may enable coordinated control over translational movement of the relocation modules 101. Similarly, the electric motors 128 for the gear pumps 126 may be connected to the central computer 150 and may be powered by dedicated power supplies 134. The electric motors 128 may drive the gear pumps 126 to generate hydraulic pressure for jack extension operations.

The circuit diagram 1100 of FIG. 11 depicts a modular power distribution approach, where each component including the central computer 150, the local computers 1102, the electric motors 111, the electric motors 128, and the wireless human machine interface 151 may be supported by a dedicated power source. This arrangement may enhance system modularity and reliability by providing independent power to each functional element. The central computer 150 may process incoming interface signals from the wireless human machine interface 151 and may issue precise control commands to coordinate both jacking and translational movement operations across all relocation modules 101.

In embodiments, the communication pathways between the central computer 150 and the local computers 1102 may enable real-time data exchange for synchronized operation. The central computer 150 may transmit control commands to each local computer 1102 for coordinated actuation of the hydraulic jacks 115 and the mecanum wheels 110. Each local computer 1102 may transmit status information back to the central computer 150, including load cell readings, motor status, and system diagnostics. This bidirectional communication may enable the central computer 150 to monitor system performance and adjust control commands in response to real-time feedback from each relocation module 101.

In embodiments, the dedicated power supplies 134 for each component may provide electrical isolation between functional elements of the relocation system 100. For example, a power supply failure in one relocation module 101 may not affect the operation of other relocation modules 101 or the central control unit 102. The modular power architecture may enable continued operation of unaffected components and may facilitate troubleshooting and maintenance by isolating electrical faults to individual subsystems.

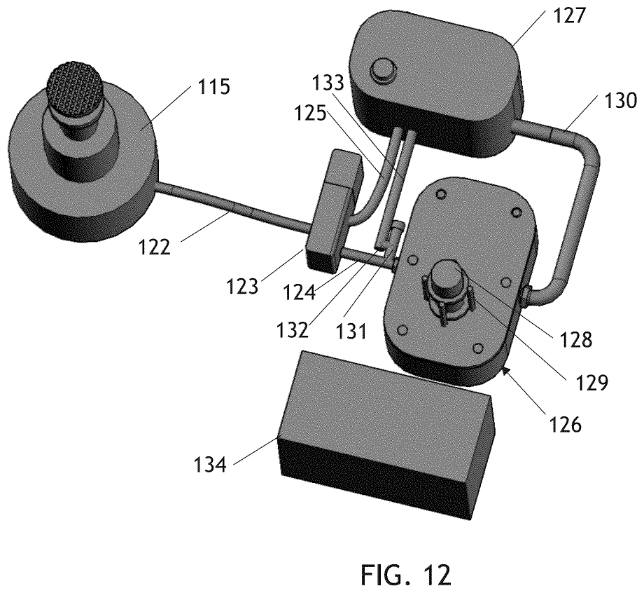

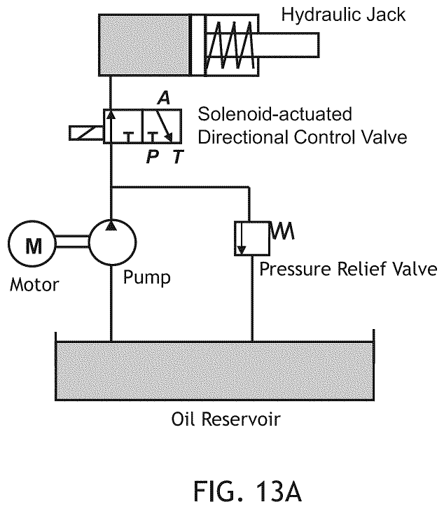

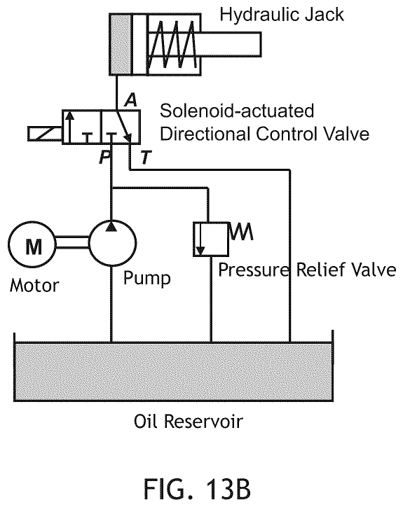

FIGS. 12-13B illustrate the hydraulic system and fluid power operation of the relocation system 100, in accordance with one or more embodiments of the present disclosure.

Referring to FIG. 12, in embodiments, the hydraulic system may include the hydraulic jack 115 connected to a hose 122, which may link to a directional control valve 123. The directional control valve 123 may be fluidly coupled to a gear pump 126 via a hose 124 and to an oil reservoir 127 via a hose 125. The gear pump 126 may be operatively coupled to an electric motor 128, which may be mounted on a motor support 129. A hose 130 may connect the gear pump 126 to the oil reservoir 127, establishing a fluid return path. A pressure relief valve 131 may be connected to a hydraulic hose fitting 132, which may link to the oil reservoir 127 via a hose 133. The pressure relief valve 131 may be configured to regulate system pressure by diverting excess fluid to the oil reservoir 127 when pressure exceeds a predetermined threshold. A power supply 134 may provide electrical power to the electric motor 128.

In embodiments, the arrangement of the hydraulic system components may enable the hydraulic jack 115 to extend and retract through controlled fluid flow. The directional control valve 123 may direct pressurized fluid from the gear pump 126 to the hydraulic jack 115 during extension operations and may allow fluid to return to the oil reservoir 127 during retraction operations.

Referring to FIG. 13A, in embodiments, the fluid power diagram illustrates the hydraulic system during extension of the hydraulic jack 115. The hydraulic jack 115 may be positioned at the top of the fluid circuit, with the directional control valve 123 fluidly coupled to the hydraulic jack 115. The directional control valve 123 may be a 3/2-way solenoid-actuated valve having a pressure port (P), an actuator port (A), and a tank port (T). The gear pump 126 may be positioned below the directional control valve 123 and may be operatively coupled to the electric motor 128, which may drive the gear pump 126 to supply pressurized fluid. The oil reservoir 127 may be positioned at the bottom of the circuit and may provide hydraulic fluid storage for the system. The pressure relief valve 131 may be connected between the gear pump 126 and the oil reservoir 127 to safeguard the system against overpressure conditions.

In embodiments, upon energization of the solenoid within the directional control valve 123, the directional control valve 123 may shift to connect the pressure port (P) to the actuator port (A) while the tank port (T) remains closed. This valve configuration may deliver pressurized fluid from the gear pump 126 to extend the hydraulic jack 115. The pressure relief valve 131 may be configured to divert excess pressure back to the oil reservoir 127 when system pressure exceeds a predetermined threshold, protecting the hydraulic system from damage due to overpressure conditions.

In embodiments, during the extension cycle, the electric motor 128 may drive the gear pump 126 to draw hydraulic fluid from the oil reservoir 127 and pressurize the fluid for delivery to the hydraulic jack 115. The pressurized fluid may flow from the gear pump 126 through the hose 124 to the pressure port (P) of the directional control valve 123. With the solenoid energized, the directional control valve 123 may route the pressurized fluid from the pressure port (P) to the actuator port (A), which may be connected to the hydraulic jack 115 via the hose 122. The pressurized fluid entering the hydraulic jack 115 may cause the telescopic cylinder to extend, lifting the vehicle.

Referring to FIG. 13B, in embodiments, the fluid power diagram illustrates the hydraulic system during retraction of the hydraulic jack 115, wherein hydraulic oil returns to the oil reservoir 127. When the directional control valve 123 is in a rest position (e.g., with the solenoid de-energized), the pressure port (P) may be closed while fluid may flow from the actuator port (A) to the tank port (T). This valve configuration may allow hydraulic fluid from the hydraulic jack 115 to return to the oil reservoir 127, enabling retraction of the hydraulic jack 115.

In embodiments, during the retraction cycle, the weight of the vehicle may act on the hydraulic jack 115, creating pressure within the telescopic cylinder that drives hydraulic fluid out of the hydraulic jack 115. The hydraulic fluid may flow from the hydraulic jack 115 through the hose 122 to the actuator port (A) of the directional control valve 123. With the solenoid de-energized, the directional control valve 123 may route the fluid from the actuator port (A) to the tank port (T), which may be connected to the oil reservoir 127 via the hose 125. The hydraulic fluid returning to the oil reservoir 127 may allow the telescopic cylinder of the hydraulic jack 115 to retract under the vehicle's weight, lowering the vehicle to the ground.

In embodiments, the single-acting configuration of the hydraulic jack 115 may utilize pressurized fluid for extension and may rely on external force (e.g., the weight of the vehicle) for retraction. This configuration may simplify the hydraulic circuit by eliminating the need for a double-acting cylinder and associated fluid pathways for powered retraction. The directional control valve 123 may provide the switching function that alternates between extension and retraction modes based on the energization state of the solenoid.

In embodiments, the pressure relief valve 131 may provide overpressure protection during both extension and retraction cycles. During extension, if system pressure exceeds the predetermined threshold due to excessive load or obstruction, the pressure relief valve 131 may open to divert excess fluid back to the oil reservoir 127, preventing damage to the hydraulic jack 115, the gear pump 126, or other hydraulic components. The pressure relief valve 131 may be configured with a preset pressure threshold that corresponds to the maximum safe operating pressure of the hydraulic system.

In embodiments, the hydraulic circuit configuration may enable coordinated control of the hydraulic jack 115 through the local computer within each relocation module 101. The local computer may control the electric motor 128 to activate the gear pump 126 and may control the solenoid of the directional control valve 123 to select between extension and retraction modes. The load cell mounted on the hydraulic jack 115 may provide feedback to the local computer, enabling automatic control of the jacking sequence based on detected load conditions.

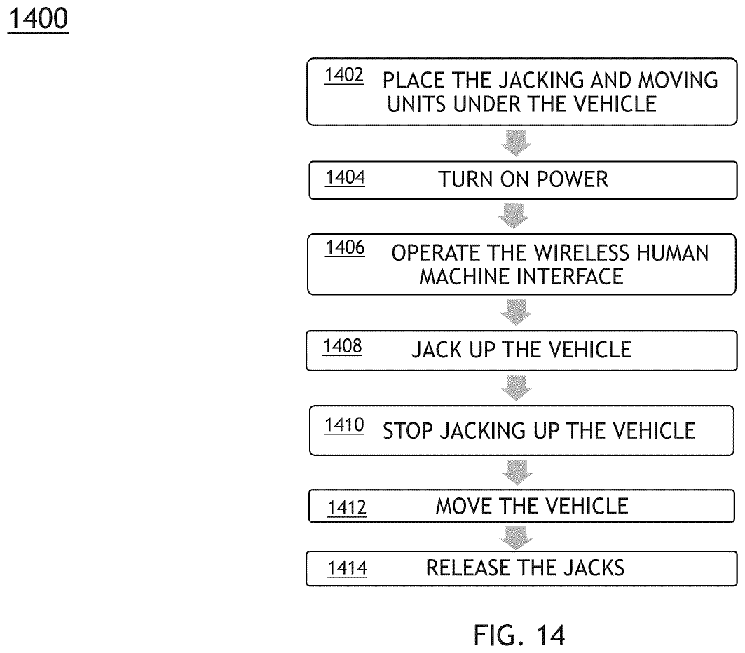

FIG. 14 illustrates a flowchart depicting a method 1400 for operating the relocation system 100, in accordance with one or more embodiments of the present disclosure. The method 1400 may provide a sequence of operations for relocating an inoperable vehicle using the portable omnidirectional relocation system 100, as previously discussed herein, where the previous discussion is herein incorporated herein, and vice versa.

In embodiments, the method 1400 may begin with a step 1402, where the relocation modules 101 may be positioned beneath the vehicle 101′. For example, positioning the plurality of relocation modules 101 may include positioning four relocation modules 101 at front-left, front-right, rear-left, and rear-right pinch weld jacking points of the vehicle 101′. Each relocation module 101 may include the hydraulic jack 115, the mecanum wheels 110, and the local computer 1102. Proper alignment at the designated jacking points may ensure stable support during subsequent operations. The low-profile design of each relocation module 101 may enable positioning beneath the vehicle 101′ without requiring preliminary elevation.

In embodiments, the method 1400 may proceed to a step 1404, where power may be supplied to all components of the relocation system 100. For example, power may be supplied to the central computer 150, the local computers 1102 within each relocation module 101, the electric motors 111 for the mecanum wheels 110, the electric motors 128 for the gear pumps 126, and the wireless human machine interface 151. Each component may receive power from a respective dedicated power supply 134, enabling distributed and reliable operation across the relocation system 100.

In embodiments, the method 1400 may continue to a step 1406, where the wireless human machine interface 151 may be operated to initiate control of the relocation system 100. For example, the wireless human machine interface 151 may be paired with the central computer 150 via Bluetooth by holding the main button 153 and the share button 154 at the same time. Once paired, the wireless human machine interface 151 may enable the operator to issue control commands for coordinated actuation across all relocation modules 101. The wireless human machine interface 151 may provide real-time control of vehicle lifting and movement functions through joystick inputs and command buttons.

In embodiments, the method 1400 may advance to a step 1408, where the vehicle 101′ may be lifted by actuating the hydraulic jacks 115 simultaneously across all relocation modules 101. For example, actuating the hydraulic jacks 115 simultaneously may include transmitting synchronized instructions from the central control unit 102 to the local computers 1102 in each of the four relocation modules 101. The central computer 150 may process the lift command from the wireless human machine interface 151 and may transmit synchronized instructions to the local computers 1102. Each local computer 1102 may control the respective gear pump motor 128 to extend the hydraulic jacks 115 evenly and simultaneously across all relocation modules 101. The telescopic cylinders of the hydraulic jacks 115 may extend evenly across all relocation modules 101 to lift the vehicle 101′ in a balanced manner.

In embodiments, actuating the hydraulic jacks 115 simultaneously may further include monitoring load cell feedback to detect when vehicle tires are lifted off the ground. The load cells 119 mounted on each hydraulic jack 115 may provide real-time feedback to the respective local computers 1102. The local computers 1102 may transmit load cell readings to the central computer 150, enabling coordinated monitoring of the lifting sequence across all relocation modules 101. The relocation system 100 may automatically halt jacking once the load cells 119 indicate tire lift-off, confirming that sufficient ground clearance has been achieved for safe movement.

In embodiments, the method 1400 may proceed to a step 1410, where the jacking process may be halted once the vehicle tires are fully elevated above the ground. For example, the relocation system 100 may automatically monitor jack extension height and pressure balance to maintain vehicle stability during the lift. The load cells 119 may detect peak load during the lifting sequence, and the relocation system 100 may automatically halt jacking once the load is held for a preset time (e.g., approximately 5 seconds). This automatic halting feature may prevent over-extension of the hydraulic jacks 115 and may ensure that the vehicle 101′ is lifted to an appropriate height without excessive force application.

In embodiments, the method 1400 may continue to a step 1412, where the vehicle 101′ may be relocated to a designated location by directing omnidirectional movement using the mecanum wheels 110. For example, directing omnidirectional movement may include receiving operator inputs from the wireless human machine interface 151. The operator may use the left stick 155 to provide proportional control of translational movement or may use the directional buttons 157, 158, 159, and 160 to control movement in forward, backward, left, and right directions, respectively.

In embodiments, directing omnidirectional movement may further include coordinating mecanum wheel speeds across all four relocation modules 101 to achieve precise translational movement. The central computer 150 may dynamically adjust wheel motor speeds based on operator inputs from the wireless human machine interface 151. The central computer 150 may transmit synchronized commands to the local computers 1102, which may control the electric motors 111 to achieve coordinated wheel rotation across all relocation modules 101.

In embodiments, directing omnidirectional movement may enable movement in forward, backward, left, right, and diagonal directions without reorienting the vehicle 101′. The mecanum wheels 110 may enable omnidirectional movement capability, allowing the vehicle 101′ to be moved in any direction within a horizontal plane without changing the vehicle's orientation. This omnidirectional movement capability may be particularly advantageous for navigating congested highway environments or confined spaces when relocating disabled vehicles.

In embodiments, the designated location may be a roadside shoulder, a repair bay, a parking area, or any other safe location away from traffic lanes. For example, the designated location may be a roadside shoulder for highway applications, enabling rapid clearance of traffic obstructions. By way of another example, the designated location may be a repair bay or service area for automotive mechanic applications, enabling mechanics to reposition vehicles in limited-space environments.

In embodiments, the method 1400 may enable single-operator control without requiring the vehicle 101′ to be placed in neutral. The mecanum wheels 110 integrated into each relocation module 101 may provide omnidirectional movement capability independent of the vehicle's drivetrain configuration. The relocation system 100 may operate without any manipulation of the vehicle's transmission, making the method 1400 suitable for electric vehicles that lack a neutral setting, as well as vehicles with transmission problems or mechanical failures that prevent normal gear selection.

In embodiments, the method 1400 may conclude with a step 1414, where the hydraulic jacks 115 may be retracted in unison to lower the vehicle 101′ to the ground. For example, the central computer 150 may transmit synchronized retraction commands to the local computers 1102 in each relocation module 101. Each local computer 1102 may control the directional control valve 123 to de-energize the solenoid, allowing hydraulic fluid to return from the hydraulic jack 115 to the oil reservoir 127. The weight of the vehicle 101′ may act on the hydraulic jacks 115, driving hydraulic fluid out of the telescopic cylinders and enabling retraction under the vehicle's weight.

In embodiments, retraction may be centrally coordinated to ensure even descent and prevent tilt or imbalance of the vehicle 101′. The central computer 150 may monitor load cell feedback from each relocation module 101 during the retraction sequence to verify balanced lowering across all four jacking points. The coordinated retraction may complete the relocation process by gently lowering the vehicle 101′ back to the ground at the designated location.

In embodiments, the method 1400 may be performed by a single operator using the wireless human machine interface 151 to control all lifting and movement operations. The operator may position the relocation modules 101 beneath the vehicle 101′, power on the relocation system 100, and control the jacking and movement sequences through the wireless human machine interface 151 without requiring assistance from additional personnel. The single-operator capability may reduce personnel requirements for vehicle relocation operations and may enable rapid deployment by police officers, emergency responders, or authorized contractors.

The computers of the present disclosure may include one or more processors and a memory. The one or more processors may be configured to execute a set of program instructions stored in the memory. The one or more processors may include any one or more processing elements known in the art. In this sense, the one or more processors may include any microprocessor device configured to execute algorithms and/or program instructions. In general, the term “processor” may be broadly defined to encompass any device having one or more processing elements, which execute a set of program instructions from a non-transitory memory medium (e.g., the memory), where the one or more sets of program instructions are configured to cause the one or more processors to carry out any of one or more process steps.

The memory may include any storage medium known in the art suitable for storing the one or more sets of program instructions executable by the associated one or more processors. For example, the memory may include a non-transitory memory medium. For instance, the memory may include, but is not limited to, a read-only memory (ROM), a random access memory (RAM), a magnetic or optical memory device (e.g., disk), a magnetic tape, a solid state drive, and the like. The memory may be configured to provide display information to the user device. In addition, the memory may be configured to store user input information from one or more user input devices. The memory may be housed in a common controller housing with the one or more processors. The memory may, alternatively or in addition, be located remotely with respect to the spatial location of the processors and/or the one or more controllers 114. For instance, the one or more processors, the one or more controllers 114 may access a remote database, accessible through a network (e.g., internet, intranet, and the like) via one or more communication interfaces.

In a general sense, those skilled in the art will recognize that the various aspects described herein which can be implemented, individually and/or collectively, by a wide range of hardware, software, firmware, or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of random access memory), and/or electrical circuitry forming a communications device (e.g., a modem, communications switch, or optical-electrical equipment). Those having skill in the art will recognize that the subject matter described herein may be implemented in an analog or digital fashion or some combination thereof.

All of the methods described herein may include storing results of one or more steps of the method embodiments in memory. The results may include any of the results described herein and may be stored in any manner known in the art. The memory may include any memory described herein or any other suitable storage medium known in the art. After the results have been stored, the results can be accessed in the memory and used by any of the method or system embodiments described herein, formatted for display to a user, used by another software module, method, or system, and the like. Furthermore, the results may be stored “permanently,” “semi-permanently,” temporarily,” or for some period of time. For example, the memory may be random-access memory (RAM), and the results may not necessarily persist indefinitely in the memory.

It is further contemplated that each of the embodiments of the method described above may include any other step(s) of any other method(s) described herein. In addition, each of the embodiments of the method described above may be performed by any of the systems described herein.

One skilled in the art will recognize that the herein described components operations, devices, objects, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components, operations, devices, and objects should not be taken as limiting.

As used herein, directional terms such as “top,” “bottom,” “over,” “under,” “upper,” “upward,” “lower,” “down,” and “downward” are intended to provide relative positions for purposes of description, and are not intended to designate an absolute frame of reference. Various modifications to the described embodiments will be apparent to those with skill in the art, and the general principles defined herein may be applied to other embodiments.

With respect to the use of substantially any plural and/or singular terms herein, those having skill in the art can translate from the plural to the singular and/or from the singular to the plural as is appropriate to the context and/or application. The various singular/plural permutations are not expressly set forth herein for sake of clarity.

The herein described subject matter sometimes illustrates different components contained within, or connected with, other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “connected,” or “coupled,” to each other to achieve the desired functionality, and any two components capable of being so associated can also be viewed as being “couplable,” to each other to achieve the desired functionality. Specific examples of couplable include but are not limited to physically mateable and/or physically interacting components and/or wirelessly interactable and/or wirelessly interacting components and/or logically interacting and/or logically interactable components.

Furthermore, it is to be understood that the invention is defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” and the like). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, and the like” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, and the like). In those instances where a convention analogous to “at least one of A, B, or C, and the like” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, and the like). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. Furthermore, it is to be understood that the invention is defined by the appended claims.

What is claimed is:

1. A portable relocation system for relocating an inoperable vehicle comprising:
a plurality of relocation modules configured to be positioned at a plurality of designated jacking points of the inoperable vehicle;
each relocation module comprising:
a chassis configured to support each relocation module;
a hydraulic jack mounted to the chassis, wherein the hydraulic jack is configured to lift the inoperable vehicle a predetermined distance relative to a ground surface;
a plurality of mecanum wheels mounted to the chassis, wherein the plurality of mecanum wheels are configured to enable omnidirectional movement; and
a local computer configured to control the hydraulic jack and the plurality of mecanum wheels;
a central control unit communicatively coupled to each local computer of each relocation module; and
a wireless human-machine interface in communication with the central control unit, wherein the central control unit synchronizes lift and omnidirectional movement of the inoperable vehicle by exchanging real-time data and control commands with each local computer of each relocation module.

2. The portable relocation system of claim 1, wherein each relocation module further comprises:
a gear pump operatively coupled to an electric motor and configured for fluid communication with an oil reservoir; and
a directional control valve fluidly coupled between the hydraulic jack and the gear pump.

3. The portable relocation system of claim 1, wherein the plurality of relocation modules comprises four relocation modules configured to be positioned at front-left, front-right, rear-left, and rear-right jacking points of the inoperable vehicle.

4. The portable relocation system of claim 1, wherein the chassis comprises:
a top plate;
two vertical edge plates;
a platform; and
a plurality of vertical stiffeners configured to transfer load from the hydraulic jack to the plurality of mecanum wheels.

5. The portable relocation system of claim 1, wherein the hydraulic jack comprises a telescopic cylinder, wherein the telescopic cylinder is configured to extend a select distance to lift the inoperable vehicle the predetermined distance relative to the ground surface.

6. The portable relocation system of claim 2, wherein the hydraulic jack further comprises:
a ram;
an extension screw;
a bearing plate;
a saddle; and
a load cell positioned between the bearing plate and the saddle, wherein load cell is configured to detect vehicle lift-off and provide feedback to the local computer for controlling extension and retraction of the hydraulic jack.

7. The portable relocation system of claim 1, wherein each relocation module comprises four mecanum wheels, each mecanum wheel being driven by a respective electric motor through a chain drive assembly comprising a large sprocket and a small sprocket connected by a chain.

8. The portable relocation system of claim 2, wherein the directional control valve includes a 3/2-way solenoid-actuated directional control valve having a pressure port, an actuator port, and a tank port.

9. The portable relocation system of claim 8, further comprising:
a pressure relief valve connected between the gear pump and the oil reservoir and configured to prevent overpressure conditions.

10. The portable relocation system of claim 1, wherein the local computer comprises:
an analog-to-digital converter configured to process signals from a load cell;
a relay driver configured to control a directional control valve; and
a power supply configured to provide electrical power to system components.

11. The portable relocation system of claim 1, wherein the central control unit communicates with each local computer via a wireless communication protocol.

12. A method for relocating an inoperable vehicle using a portable relocation system comprising:
positioning a plurality of relocation modules at respective designated jacking points of the inoperable vehicle, each relocation module including a hydraulic jack, a plurality of mecanum wheels, and a local computer;
actuating the hydraulic jack for each relocation module simultaneously across the plurality of relocation modules to lift the inoperable vehicle a predetermined distance relative to a ground surface;
directing omnidirectional movement of the inoperable vehicle using the plurality of mecanum wheels to move the inoperable vehicle to a predetermined location; and
retracting the hydraulic jack for each relocation module simultaneously across the plurality of relocation modules to lower the inoperable vehicle to the ground surface.

13. The method of claim 12, wherein positioning the plurality of relocation modules comprises:
positioning four relocation modules at front-left, front-right, rear-left, and rear-right pinch weld jacking points of the inoperable vehicle.

14. The method of claim 13, wherein actuating the hydraulic jack simultaneously comprises:
transmitting synchronized instructions from a central control unit to each local computer in each of the four relocation modules;
extending telescopic cylinders of each hydraulic jack evenly across the plurality of relocation modules; and
monitoring load cell feedback to detect when vehicle tires are lifted off the ground surface using one or more load cells.

15. The method of claim 14, wherein directing omnidirectional movement comprises:
receiving operator inputs from a wireless human-machine interface;
coordinating mecanum wheel speeds across all four relocation modules to achieve precise translational movement; and
enabling movement in forward, backward, left, right, and diagonal directions without reorienting the inoperable vehicle.

16. The method of claim 12, wherein the predetermined location includes at least one of a roadside shoulder or repair bay, wherein the method enables single-operator control without requiring the inoperable vehicle to be placed in neutral.

17. A relocation module for relocating an inoperable vehicle comprising:
a chassis configured to fit beneath a plurality of vehicle pinch-weld jacking points;
a hydraulic jack including a four-stage telescopic cylinder mounted to the chassis;
a plurality of mecanum wheels mounted to the chassis, wherein the plurality of mecanum wheels are configured to enable omnidirectional movement;
a gear pump operatively coupled to an electric motor;
a solenoid-actuated directional control valve fluidly coupled between the hydraulic jack and the gear pump;
a load cell mounted on the hydraulic jack, wherein the load cell is configured to measure distributed vehicle weight of the inoperable vehicle; and
a local computer configured to control hydraulic jack extension and retraction of the four-stage telescopic cylinder and mecanum wheel motion of the plurality of mecanum wheels based on real-time sensor feedback from the load cell.

18. The relocation module of claim 17, wherein the chassis comprises:
a top plate having an opening configured to receive the hydraulic jack;
two vertical edge plates containing holes for receiving one or more axles;
a platform positioned below the top plate; and
a plurality of vertical stiffeners configured to transfer load from the hydraulic jack to the plurality of mecanum wheels.

19. The relocation module of claim 17, wherein each of the plurality of mecanum wheels is driven by a respective electric motor through a chain drive assembly comprising a large sprocket mounted adjacent to a respective mecanum wheel and a small sprocket connected to the electric motor via a chain.

20. The relocation module of claim 17, further comprising:
an oil reservoir configured for fluid communication with the gear pump;
a pressure relief valve connected between the gear pump and the oil reservoir, wherein the pressure relief valve is configured to prevent overpressure conditions; and
a swivel caster mounted to the chassis, wherein the swivel caster is configured to provide mobility when the hydraulic jack is not engaged.
